(19) United States
(12) Patent Application Publication
(10) Pub. No.: US 2005/0288889 A1
(43) Pub. Date: Dec. 29, 2005

(54) Method and system for assessing consumed tolerances for individual features of a pattern and accommodating errors due to such individual features

(75) Inventors: Bruce A. Wilson, O'Fallon, MO (US); Paul C. Hollingshead, Florissant, MO (US)

Correspondence Address: SHIMOKAJI & ASSOCIATES, P.C., 8911 RESEARCH DRIVE, IRVINE, CA, 92618, US

(73) Assignee: The Boeing Company, Chicago, IL (US)

(21) Appl. No.: 10/860,088

(22) Filed: Jun. 1, 2004

(51) Int. Cl. G01B 15/00; G01B 7/00; G06F 15/00

(52) U.S. Cl. 702/155

(57) ABSTRACT

One aspect is a method for evaluating feature relating tolerance compliance for an individual feature of a pattern of features, for example using a pattern construct indicative of consumed tolerance of the pattern, or a pattern construct including a maximum inscribed circle inscribed within (or a minimum circumscribing circle which circumscribes) feature figures indicative of the features. Other aspects are computer-readable media (e.g., compact disks or tapes) that store code for programming a processor to implement any embodiment of the inventive method, and computer systems programmed to perform any embodiment of the inventive method.

### CROSS-REFERENCE TO RELATED APPLICATIONS

This application is related to U.S. patent application Ser. No. 10/792,089, filed on Mar. 2, 2004, and U.S. patent application Ser. No. 10/800,383, filed on Mar. 12, 2004, both of which are pending. The full text of each of application Ser. No. 10/792,089 and application Ser. No. 10/800,383 is incorporated herein by reference.

### BACKGROUND OF THE INVENTION

The present invention generally relates to the production of articles of manufacture in a computer simulation or in the real world, and more particularly, to a method and system for accurately evaluating pattern compliance for a simulated or manufactured article (having a pattern of features), determining consumed tolerances for individual features of such a pattern, and determining whether (and if so how) any violation of allowable tolerances may be accommodated.

Throughout the disclosure, and in the claims, the term “manufactured” (as in a “manufactured” article, pattern, or feature) without a modifier is used in bròad sense to denote either actually manufactured (manufactured in the real world) or simulated (determined by simulation data).

American, Canadian, German, and International Organization for Standardization (ISO) standards define methods for specifying multiple levels of pattern and feature related tolerances often referred to as composite positional tolerances. Composite positional tolerances include a pattern locating tolerance and a feature relating tolerance. A pattern locating tolerance is a tolerance that relates a collection of manufactured features on an object relative individually to the specified datums of the designed pattern. A feature relating tolerance can be a tolerance that is linked to the produced size of a feature, that controls the positions of a set of features relative to each other, and/or controls the rotation of a pattern of features relative to a specified origin.

A tolerance specification may be applicable at maximum material condition (MMC) or least material condition (LMC). MMC may be defined as the condition in which a feature of size contains the maximum amount of material within the stated limits of size, for example, minimum hole diameter or maximum shaft diameter. LMC may be defined as the condition in which a feature of size contains the least amount of material within the stated limits of size, for example, maximum hole diameter, or minimum shaft diameter. An allowable tolerance may be specified as the combination of the feature relating tolerances and the departure from a material condition.

In general, manufactured features are subject to variation in size, form, orientation, and position. These kinds of variation may be considered separately, but for simplification of explanation, form and size variations are typically considered together and referred to as size variation. In the same manner, orientation and positional variation are typically considered together and referred to as positional or location error.

With reference to FIG. 1, one method for documenting inspection data consists of paper gauging in which information is recorded on paper. Measurements are taken and errors are plotted on a grid 94 at an enlarged scale using a true position 96 as the origin. Hole positions 92 are then plotted on the grid 94. Concentric circles 90 representing tolerance zone diameters are then overlaid to determine positional errors. This method is time consuming because it is not automated, and it is not used with an automated process. Another problem with the method is the difficulty of best fitting the concentric circles 90 into a position that encompasses all the hole positions 92 within the applicable concentric circle.

Another method for documenting inspection and simulation data uses variation analysis software that assesses feature related tolerances. Approximations and iterations are used that combine size, orientation, and location variations. Multiple iterations of inspecting feature size and positions are used to increase accuracy. However, using approximations reduces accuracy, and using multiple iterations causes excessive analysis time.

Variation effects within a pattern of features may be determined when performing a variation analysis of a design prior to manufacturing that design. The variation analysis software performs hundreds or thousands of simulated build cycles, and in each cycle, varies all of the parameters randomly. Assembly variation analysis that utilizes feature patterns, such as holes, for assembly is currently reliant on approximations and iterations for the assembly of parts. Such a process may introduce error, is inefficient, and requires advanced software skills for completion.

When multiple features of a pattern are produced with size and location variation that are within the allowable positional tolerances, the amount of tolerance used by each of the features may need to be determined. An aspect of the present invention is to provide methods that are useful to accomplish such a determination.

As can be seen, there is a need for accurately evaluating inspection and simulation data. There is also a need for evaluating inspection and simulation data in a timely manner, preferably with only a single iteration. Moreover, there is a need for quickly analyzing inspection and simulation data in a step of the manufacturing process so that the results of the analysis can be used in subsequent processes. In addition to the need for assessing produced parts, there is a need to accurately determine the variation effects on patterns of features (resulting from variation of individual features of patterns) during variation analysis. Important benefits of typical embodiments of the invention include making set-up easier and less time-consuming for assessing consumed tolerances for individual features of a pattern and determining whether (and if so how) any violation of allowable tolerances may be accommodated, making the results of such assessments less ambiguous, sometimes also reducing run time during simulations.

### SUMMARY OF THE INVENTION

In an aspect of the present invention, a method for evaluating compliance of an individual feature of a pattern of features with a virtual condition includes the steps of determining, from data indicative of the pattern, a pattern construct that is indicative of relative positions of the features and is also indicative of at least one of remaining allowable tolerance of the pattern and consumed tolerance of the pattern; and using the pattern construct to evaluate compliance of the individual feature with the virtual condition.

In another aspect of the present invention, a method for evaluating compliance of an individual feature of a pattern of internal features with a virtual condition includes the steps of: determining, from data indicative of the pattern, a pattern construct that is indicative of relative positions of the features and is also indicative of at least one of remaining allowable tolerance of the pattern and consumed tolerance of the pattern, wherein the pattern construct includes a maximum inscribed circle which is inscribed within feature figures indicative of all the features in relative positions determined by the pattern construct; and using the pattern construct to evaluate compliance of the individual feature with the virtual condition, including by determining from the maximum inscribed circle and the virtual condition whether the pattern violates a set of allowable feature relating tolerances.

In another aspect of the present invention, a method for evaluating compliance of an individual feature of a pattern of external features with a virtual condition includes the steps of determining, from data indicative of the pattern, a pattern construct that is indicative of relative positions of the features and is also indicative of at least one of remaining allowable tolerance of the pattern and consumed tolerance of the pattern, wherein the pattern construct includes a minimum circumscribing circle which circumscribes feature figures indicative of all the features in relative positions determined by the pattern construct; and using the pattern construct to evaluate compliance of the individual feature with the virtual condition, including by determining from the minimum circumscribing circle and the virtual condition whether the pattern violates a set of allowable feature relating tolerances.

In another aspect of the invention, a method for evaluating compliance of an individual feature of a pattern of external features with a virtual condition includes the steps of determining (from data indicative of the pattern) a pattern construct indicative of relative positions of the features and also indicative of at least one of remaining allowable tolerance of the pattern and consumed tolerance of the pattern, wherein the pattern construct includes feature figures and a minimum circumscribing circle that circumscribes the feature figures, the minimum circumscribing circle has a center, the feature figures are indicative of shapes of all the features and have relative positions determined by the pattern construct, and the feature figures include a feature figure for the individual feature; using the pattern construct to evaluate compliance of the individual feature with the virtual condition, including by determining the individual feature's contribution to a violation of a set of allowable feature relating tolerances using data indicative of a virtual condition figure centered at the center of the minimum circumscribing circle, wherein the virtual condition figure has a radius; and determining a remaining allowable tolerance of a modified version of the individual feature, from the pattern construct, data indicative of a modified version of the individual feature, and data indicative of the radius of the virtual condition figure.

In another aspect of the present invention, a machine-readable medium stores code for programming a computer to evaluate compliance of an individual feature of a pattern of features with a virtual condition, including by determining, from data indicative of the pattern, a pattern construct that is indicative of relative positions of the features and is also indicative of at least one of remaining allowable tolerance of the pattern and consumed tolerance of the pattern; and using the pattern construct to evaluate compliance of the individual feature with the virtual condition.

In another aspect of the present invention, a machine-readable medium stores code for programming a computer to evaluate compliance of an individual feature of a pattern of internal features with a virtual condition, including by determining, from data indicative of the pattern, a pattern construct that is indicative of relative positions of the features and is also indicative of at least one of remaining allowable tolerance of the pattern and consumed tolerance of the pattern, wherein the pattern construct includes a maximum inscribed circle which is inscribed within feature figures indicative of all the features in relative positions determined by the pattern construct; and using the pattern construct to evaluate compliance of the individual feature with the virtual condition, including by determining from the maximum inscribed circle and the virtual condition whether the pattern violates a set of allowable feature relating tolerances.

In another aspect of the present invention, a machine-readable medium stores code for programming a computer to evaluate compliance of an individual feature of a pattern of external features with a virtual condition, including by: determining, from data indicative of the pattern, a pattern construct that is indicative of relative positions of the features and is also indicative of at least one of remaining allowable tolerance of the pattern and consumed tolerance of the pattern, wherein the pattern construct includes a minimum circumscribing circle which circumscribes feature figures indicative of all the features in relative positions determined by the pattern construct; and using the pattern construct to evaluate compliance of the individual feature with the virtual condition, including by determining from the minimum circumscribing circle and the virtual condition whether the pattern violates a set of allowable feature relating tolerances.

In another aspect of the present invention, a computer system includes a processor programmed to evaluate compliance of an individual feature of a pattern of features with a virtual condition, including by determining, from data indicative of the pattern, a pattern construct that is indicative of relative positions of the features and is also indicative of at least one of remaining allowable tolerance of the pattern and consumed tolerance of the pattern; and using the pattern construct to evaluate compliance of the individual feature with the virtual condition.

In another aspect of the present invention, a computer system includes a processor programmed to evaluate compliance of an individual feature of a pattern of internal features with a virtual condition, including by: determining, from data indicative of the pattern, a pattern construct that is indicative of relative positions of the features and is also indicative of at least one of remaining allowable tolerance of the pattern and consumed tolerance of the pattern, wherein the pattern construct includes a maximum inscribed circle which is inscribed within feature figures indicative of all the features in relative positions determined by the pattern construct; and using the pattern construct to evaluate compliance of the individual feature with the virtual condition, including by determining from the maximum inscribed circle and the virtual condition whether the pattern violates a set of allowable feature relating tolerances.

In another aspect of the present invention, a computer system includes a processor programmed to evaluate compliance of an individual feature of a pattern of external features with a virtual condition, including by determining, from-data indicative of the pattern, a pattern construct that is indicative of relative positions of the features and is also indicative of at least one of remaining allowable tolerance of the pattern and consumed tolerance of the pattern, wherein the pattern construct includes a minimum circumscribing circle which circumscribes feature figures indicative of all the features in relative positions determined by the pattern construct; and using the pattern construct to evaluate compliance of the individual feature with the virtual condition, including by determining from the minimum circumscribing circle and the virtual condition whether the pattern violates a set of allowable feature relating tolerances.

These and other features, aspects and advantages of the invention will become better understood with reference to the following drawings, description and claims.

### BRIEF DESCRIPTION OF THE DRAWINGS

FIG. 1 is a diagram illustrating a prior art paper gauging technique for documenting inspection data;

FIG. 2 is a diagram illustrating the designed features for a rectangular plate having four holes, which can be used in accordance with an aspect of the present invention;

FIG. 3 is a diagram illustrating the feature related tolerance zone framework (FRTZF) for the rectangular plate in FIG. 2, which can be used in accordance with an aspect of the present invention;

FIG. 4 is a diagram illustrating a manufactured rectangular plate, which can be used in accordance with an aspect of the present invention;

FIG. 5 is a diagram illustrating the positional errors and true positions of each manufactured hole of FIG. 4 relative to a trial best fit framework, which can be used in accordance with an aspect of the present invention;

FIG. 6 is a diagram illustrating the true positions and the centers of each manufactured hole of FIG. 4 relative to a best fit framework, which can be used in accordance with an aspect of the present invention;

FIG. 7 is a diagram illustrating a pattern construct indicative of a one true position and manufactured holes relative to the one true position, which can be generated in accordance with an aspect of the present invention;

FIG. 8 is a diagram illustrating inscribed circles, manufactured holes and a one true position, which can be generated in accordance with an aspect of the present invention;

FIG. 9 is a flowchart illustrating a method for determining the positional error and remaining feature related tolerance for a pattern of internal features on an object, in accordance with an aspect of the present invention;

FIG. 10 is a diagram illustrating a construct indicative of an internal feature and a virtual condition, which can be generated in accordance with an aspect of the present invention;

FIG. 11 is diagram illustrating a construct indicative of an external feature and a virtual condition, which can be generated in accordance with an aspect of the present invention;

FIG. 12 is a diagram illustrating a designed rectangular plate, which can be used in accordance with an aspect of the present invention;

FIG. 13 is a diagram illustrating a manufactured rectangular plate having the FIG. 12 design, which can be used in accordance with an aspect of the present invention;

FIG. 14 is a diagram of centers of the manufactured holes of FIG. 13 relative to a one true position, a pattern locating tolerance zone about the one true position, and a feature relating circle, which can be used in accordance with an aspect of the present invention;

FIG. 15 is a diagram of centers of manufactured holes relative to a one true position, which can be used in accordance with an aspect of the present invention;

FIG. 16 is a diagram illustrating a material condition for each hole center of FIG. 15, which can be used in accordance with an aspect of the present invention;

FIG. 17 is a diagram of constructs generated to determine a feature relating tolerance for the pattern in FIG. 16, which can be used in accordance with an aspect of the present invention;

FIG. 18 is a diagram of constructs generated to determine a feature relating tolerance, which can be used in accordance with an aspect of the present invention;

FIG. 19 is a diagram of a construct generated in accordance with an aspect of the invention, which can be used in accordance with an aspect of the present invention;

FIG. 20 is a diagram of a construct generated in accordance with an aspect of the invention;

FIG. 21 is a block diagram of a computer system for implementing any embodiment of the inventive method;

FIG. 22 is an elevational view of a computer readable optical disk on which is stored computer code for implementing any embodiment of the inventive method;

FIG. 23 is a flowchart of steps performed in some embodiments of the inventive method;

FIG. 24 is a flowchart of steps performed in some other embodiments of the inventive method; and

FIG. 25 is a flowchart of steps performed in some other embodiments of the inventive method.

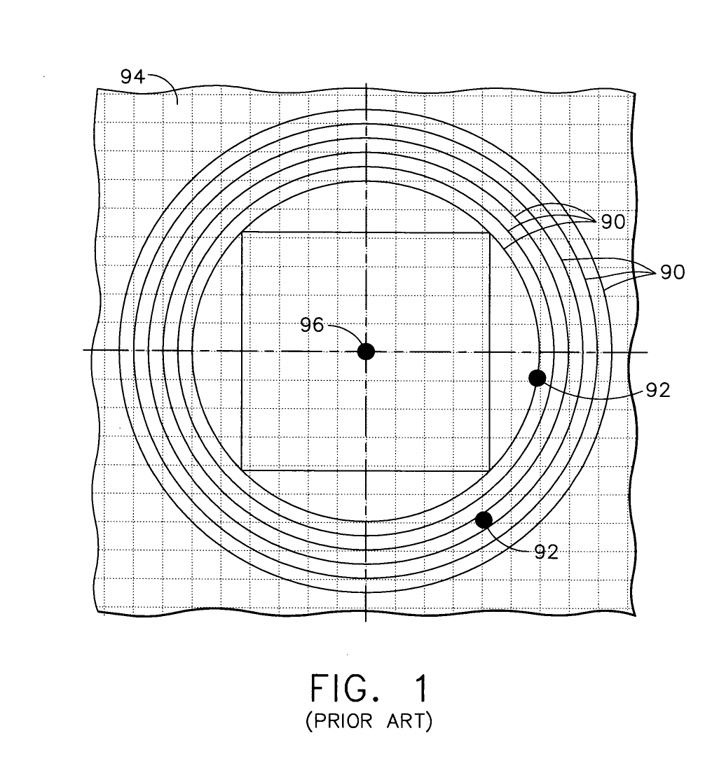

### DETAILED DESCRIPTION OF THE INVENTION

The following description is of the best currently contemplated modes of carrying out the invention. The description is not to be taken in a limiting sense, but is made merely for the purpose of illustrating the general principles of the invention since the scope of the invention is defined by the appended claims. Although embodiments of the invention are described with reference to features of manufactured patterns, such references apply equally well to features generated in computer simulations and to features produced in fabrication processes.

In a broad sense, aspects of some embodiments of the invention facilitate determination of features that contribute to failed assemblies of manufactured items (e.g., assemblies of airplanes or other systems that include assemblies), determination of instances in which parts can be reworked within allowable tolerances, and identification of instances that are hard failures. Some embodiments of the invention may be useful to evaluate produced parts of manufactured items (e.g., parts of airplanes or other systems) to determine specific features that have violated requirements of feature relating tolerances, to determine appropriate rework to make the parts acceptable, or to determine the magnitude of error that cannot be accommodated through rework.

In some embodiments, the invention provides a method for evaluating compliance of an individual feature of a pattern of features (e.g., a simulated manufactured pattern or an actually manufactured pattern) with a virtual condition, including the steps of determining (from data indicative of the pattern) a pattern construct that is indicative of relative positions of the features and is also indicative of at least one of remaining allowable tolerance of the pattern and consumed tolerance of the pattern, and using the pattern construct to evaluate compliance of the individual feature with the virtual condition. Conventionally, such a pattern construct had not been used for this purpose. The pattern construct can include a maximum inscribed circle inscribed within feature figures (indicative of the features) whose relative positions are determined by the pattern construct, or a minimum circumscribing circle which circumscribes feature figures (indicative of the features) whose relative positions are determined by the pattern construct. Alternatively, the pattern construct can include departure circles (each having a diameter indicative of a size departure of one of the features relative to a true size for that feature) and a consumed tolerance circle indicative of the consumed tolerance of the pattern. Typically (but not in all implementations), the method includes steps of determining the size and location of simulated or manufactured features of an object, determining a pattern construct indicative of the features, and determining a consumed tolerance (or the magnitude of a tolerancing violation) for at least one feature of a pattern of features. Some such methods may be hand-implemented, others may be implemented by a programmed computer (or other processing system), and others may be implemented in hardware or firmware. The data collected from each analysis of a part may be used to determine algorithms to predict future remaining feature tolerances. In some embodiments, the method may be implemented by a programmed computer. Other aspects of the invention are computer-readable media (e.g., compact disks or tapes) that store code for programming a processor to implement any embodiment of the inventive method, and computer systems programmed to perform any embodiment of the inventive method.

Various methods are described in above-referenced application Ser. Nos. 10/792,089 and 10/800,383 for performing combined feature dimensional parameter analysis (e.g., evaluation of pattern compliance for an actually manufactured or simulated article), and dimensional parameter analysis of an individual feature of a pattern. Some such methods (e.g., some of the methods described in application Ser. No. 10/792,089) employ information about the actual shape of each manufactured feature (e.g., data indicative of a multitude of selected surface points of each manufactured or simulated feature); others (e.g., some of the methods described in U.S. application Ser. No. 10/800,383) require information about the size and position but not the actual shape of each manufactured or simulated feature. Some embodiments of the method of the present invention include at least some steps performed in accordance with the teaching of above-referenced application Ser. No. 10/792,089 and U.S. application Ser. No. 10/800,383.

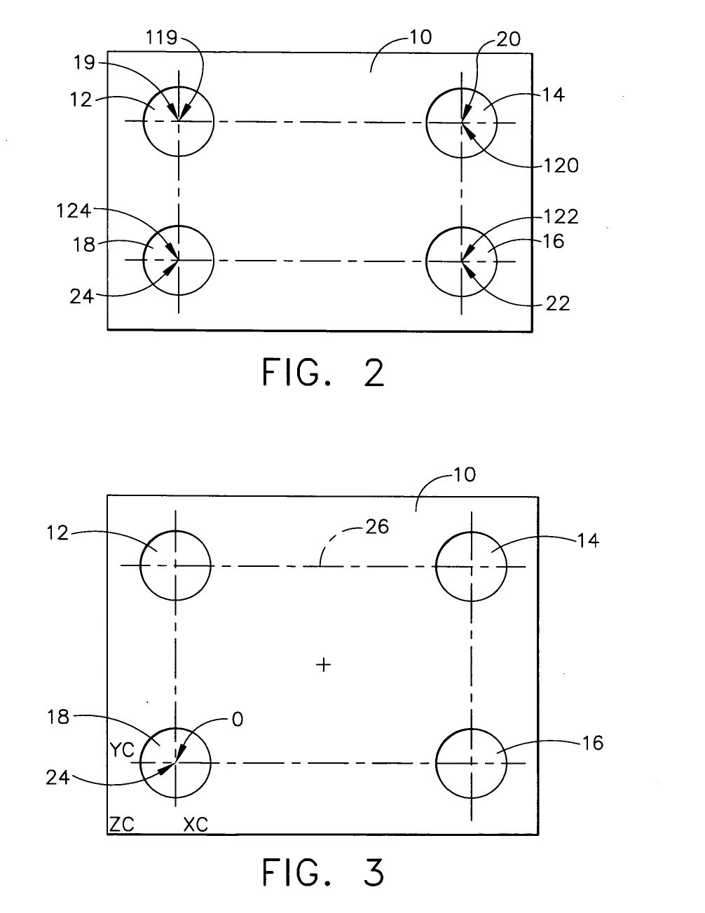

FIG. 2 is a diagram of designed features of an object, which can be a part and will be referred to below as a part. Part design 10 of FIG. 2 is a design for a rectangular plate having features including four spaced-apart circular holes 12, 14, 16, 18. While circular holes are used in the example, a feature may also be, but not limited to, polygonal or oval. Each of the designed circular holes 12, 14, 16, 18 has a center, referred to as true center 19, 20, 22, 24, respectively, and a designed size, referred to as a true size. Each hole 12, 14, 16, 18 has a designed position (referred to as a true position) in design 10. Multiple points on a feature may be used to track the position of a feature between the feature's designed (true) position and the feature's manufactured position. For example, for a rectangular hole, points on the surface of the sides and at the corners may be used or the center of the rectangle may be used. For a circular hole, the center of the hole may be used. True centers 19, 20, 22, 24 may be used as the true positions 119, 120, 122, 124 of holes 12, 14, 16, 18, respectively. A computer aided drafting (CAD) system can be used to render the diagram. The information regarding holes 12, 14, 16, and 18 may be determined by digital data stored on a machine-readable medium (e.g., a hard drive or optical disk), and can be processed by an appropriately programmed computer.

In FIG. 3, frame 26 is determined by a feature related tolerance zone framework (FRTZF) for design 10 of FIG. 2. Frame 26 will sometimes be referred to below as “FRTZF 26.” An FRTZF provides relational information that accounts for the tolerances of each feature, and the relation between the tolerances of each feature in relation to a whole pattern of features. In a typical case, a four-pin plate having four pins (or another plate having four holes) is to be mated to the rectangular plate having design 10, with the four pins inserted into holes 12, 14, 16, and 18 (or the hole patterns aligned and bolts passed through both parts). An FRTZF for the design 10 would provide the maximum tolerances that if exceeded, would prevent the features in the two parts from aligning. An xyz coordinate system for the FRTZF may use the center 24 of the bottom left circle 18 as the origin O, and the true positions 119, 120, 122 of the other circles 12,14,16 as reference points (FIG. 2).

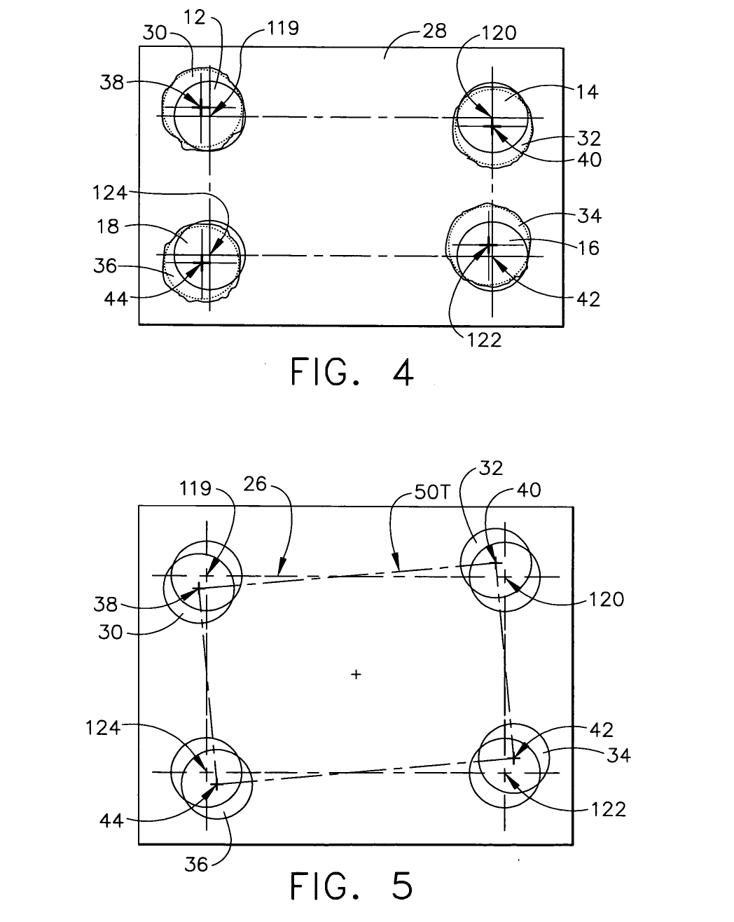

FIG. 4 is a diagram illustrating manufactured rectangular plate 28 created from design 10 of FIG. 2. The manufactured holes 30, 32, 34, and 36 correspond to designed holes 12, 14, 16 and 18. Manufactured rectangular plate 28 can be a real-world manufactured plate or a simulated manufactured plate. Manufactured holes 30, 32, 34, and 36 can represent real-world or simulated manufactured holes. Simulated holes may be generated to provide a variation analysis model of a rectangular plate. Manufactured holes 30, 32, 34, and 36 typically exhibit variation from the true size and location determined by design 10. Designed holes 12, 14, 16 and 18 define where manufacture holes 30, 32, 34, and 36 are supposed to be. As shown in FIG. 4, each manufactured hole 30, 32, 34, 36 has deviated from the true size as well as the true position. A manufactured hole that deviates from true size may be larger or smaller than the designed hole and/or may have a shape different from that of the designed hole (e.g., a shape with inner surface irregularity or roughness, where the designed hole has a smooth cylindrical surface). Each manufactured hole may have a positional error relative to its true position. The positional error may be determined by the distance between center 38, 40, 42, 44 of each manufactured hole 30, 32, 34, 36 and the true positions 119, 120, 122, 124, respectively. The deviations may extend along the depth of each hole. Data regarding the dimensions and position of the manufactured rectangular plate 28 may be acquired by many methods known in the art, including, but not limited to, examining the plate 28 with a device such as a coordinate measuring machine.

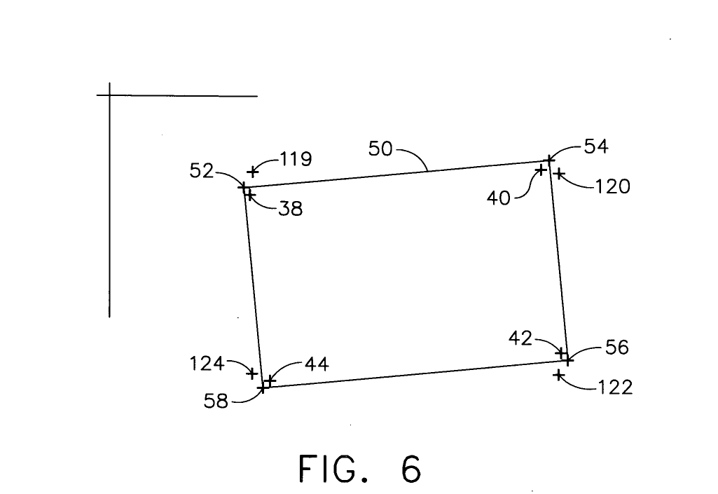

FIG. 5 is a diagram illustrating the positional errors of each manufactured hole 30, 32, 34, 36 and the true positions 119, 120, 122, 124 of each hole of design 10, relative to a trial best fit tolerance zone framework (best fit framework) 50T. Framework 50T of FIG. 5 is a rotated and translated version of FRTZF 26 which is positioned to fit well with centers 38, 40, 42, and 44 of manufactured holes 30, 32, 34, and 36. A best fit framework 50 (shown in FIG. 6) can be determined by best fitting FRTZF 26 to the manufactured holes 30, 32, 34, 36, e.g., by best fitting the true positions 19, 20, 22, 24 to the centers 38, 40, 42, 44 of manufactured holes 30, 32, 34, 36, while retaining the structure of the FRTZF 26. Examples of best fit methods are well known in the art and include, but are not limited to, a least squares or total least squares method. The best fit of the FRTZF 26 may be a version of FRTZF 26 that has translated and/or rotated relative to the FRTZF's original position, resulting in best fit framework 50.

FIG. 6 is a diagram illustrating the true positions 119,120, 122, 124 of each hole of design 10 and the centers 38, 40, 42, 44 of each manufactured hole relative to best fit framework 50. The best fit framework 50 establishes transformed true positions for each hole, where each transformed true position 52, 54, 56, 58 represents a true position 119, 120, 122, 124, respectively, that has rotated and/or translated with the FRTZF 26 (FIG. 5) when producing the best fit framework 50. Comparing best fit framework 50 with FRTZF 26 indicates how much the holes of pattern 10 have transformed, e.g., translated and rotated. The translation and rotation of a pattern of features may be evaluated relative to an origin located at, but not limited to, a true position of a circle, an edge of the manufactured part, a corner of a manufactured part, and a location on a part to be mated with the manufactured part.

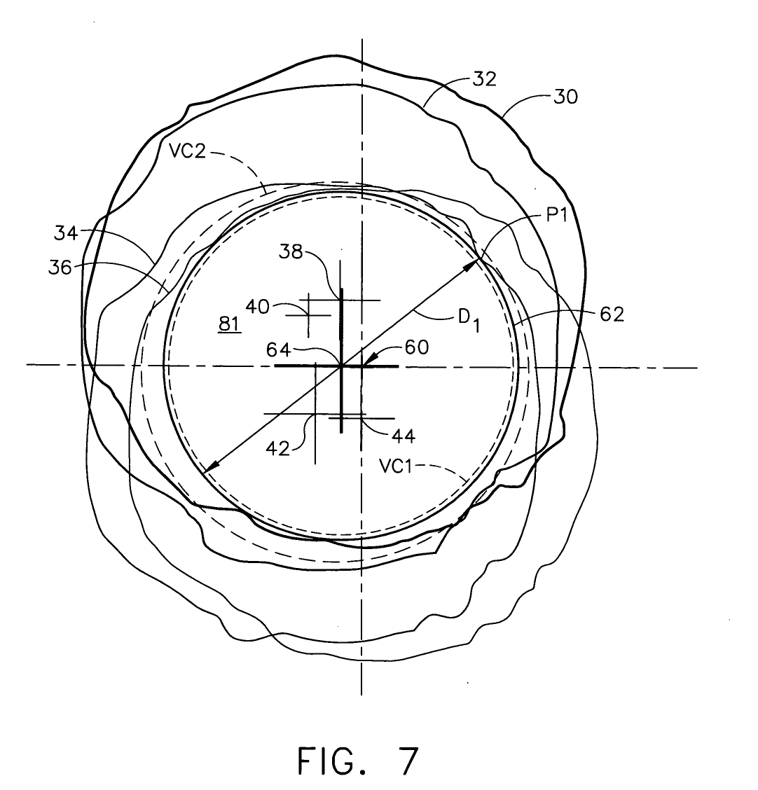

FIG. 7 is a diagram illustrating an alignment, employed in some embodiments of the invention, indicative of the relationship between each of manufactured holes 30, 32, 34, 36 and “one true position” 60. One true position 60 is a single association determined by superimposing each of transformed true positions 52, 54, 56, 58 (FIG. 6) of the best fit framework 50 onto each other. In FIG. 7, the surface of each of manufactured holes 30, 32, 34, 36 (and the center 38, 40, 42, or 44 of each of holes 30, 32, 34, and 36) respectively has the same relation to one true position 60 that it does to the corresponding one of transformed true positions 52, 54, 56, and 58 in FIG. 6. The dimensions of manufactured holes 30, 32, 34 and 36 may be determined by selecting a number (typically a large number) of points on the surface of each hole 30, 32, 34, and 36, and determining the dimensions from the selected points. The center of each manufactured hole may be established first. A circle 62 (having center 64) having the largest possible diameter is inscribed within the area 81 defined within (and common to) all of the manufactured holes 30, 32, 34, 36. The position of inscribed circle 62's center 64 relative to the one true position 60 determines the amount of translation of the pattern of features relative to the best fit framework 50 (shown in FIG. 6). The difference between the diameter D1 of the inscribed circle 62 and a virtual condition is a remaining allowable feature relating tolerance for the pattern of holes as a group. The virtual condition can be represented as a circle (e.g., circle VC1 of FIG. 7) having a diameter determined by the collective effects of a specified maximum material condition (MMC) or least material condition (LMC) for a feature (or each feature of a pattern) and a specified geometric tolerance for each such material condition. For a hole, the virtual condition is typically equal to the MMC (the smallest size that the hole may be) minus the positional tolerance for that hole. MMC may be defined as the condition in which a feature of size contains the maximum amount of material within the stated limits of size-for example, the minimum hole diameter for a hole. LMC may be defined as the condition in which a feature of size contains the least amount of material within the stated limits of size, for example, maximum hole diameter for a hole.

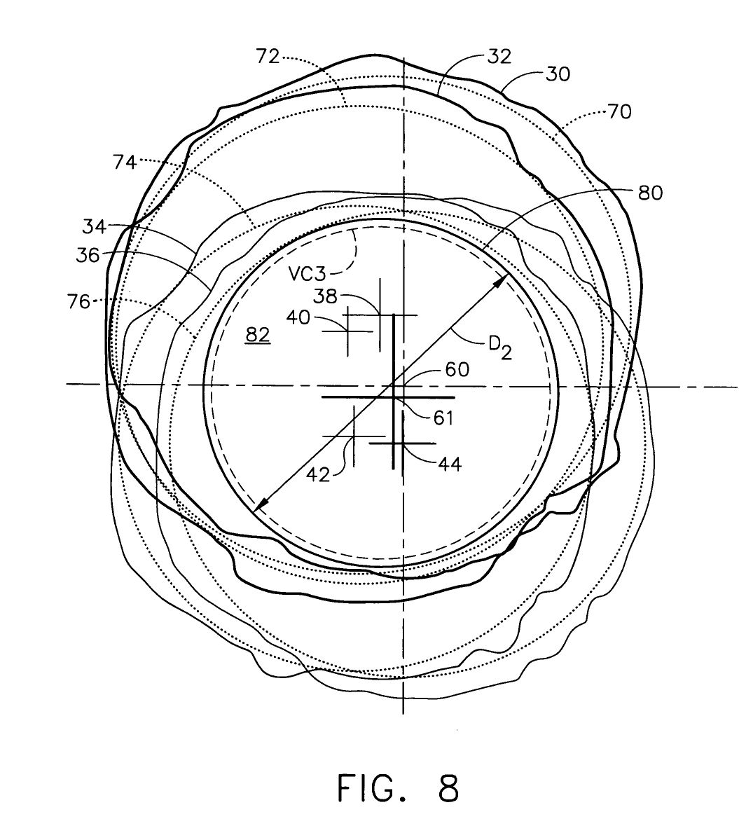

FIG. 8 is a diagram illustrating an alignment, employed in some embodiments of the invention, using inscribed circles 70, 72, 74, 76 for each manufactured hole 30, 32, 34, 36 to find a maximum inscribed circle 80. Similar to the procedure described with reference to FIG. 7, a one true position 60 is determined by superimposing each of the transformed true positions 52, 54, 56, 58 of the best fit framework 50 (of FIG. 6) onto each other. The surface (and center) of each of manufactured holes 30, 32, 34, 36 is represented relative to the one true center. A circle 70, 72, 74, 76 having the largest possible diameter is inscribed within each of the so-aligned manufactured holes 30, 32, 34, 36, respectively. Centers 38, 40, 42, 44 of holes 30, 32, 34, 36 are located at the centers of circles 70, 72, 74, 76. A circle 80 having a maximum diameter is then inscribed within the area 82 defined by (common to) inscribed circles 70, 72, 74, and 76 as shown in FIG. 8. The position of inscribed circle 80's center 61 relative to the one true position 60 determines the amount of translation of the pattern of features relative to the best fit framework 50. The difference between the diameter D₂ of inscribed circle 80 and the virtual condition (Vc) equals the remaining allowable feature relating tolerance.

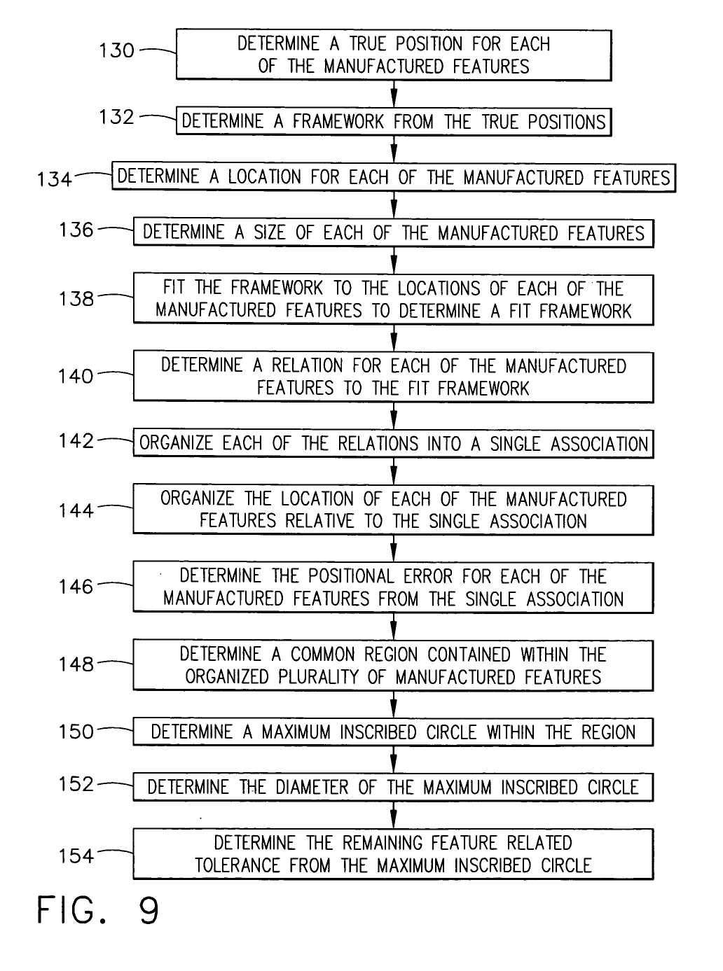

FIG. 9 is a flowchart of steps employed in some embodiments of the inventive method for determining positional error and remaining feature related tolerance for a pattern of features on an object. In the FIG. 9 embodiments, positional error and remaining feature related tolerance for a pattern of internal features are determined by a step (130) of determining a true position (i.e., an ideal position predetermined by a design) for each of the manufactured features. An example of step 130 is found in the description of FIG. 3. The FIG. 9 embodiments also include a step (132) of determining a framework from the true positions. An example of step 132 is found in the description of FIG. 4. The FIG. 9 embodiments also include a step (134) of determining a location (i.e., an actual or simulated position) for each of the manufactured features. An example of step 134 is found in the description of FIG. 4. The FIG. 9 embodiments also include a step (136) of determining a size of each of the manufactured features. An example of step 136 is found in the description of FIG. 4. The FIG. 9 embodiments also include a step (138) of fitting the framework to the locations (determined in step 134) of each of the manufactured features to determine a fit framework. An example of step 138 is found in the description of FIGS. 5 and 6.

The FIG. 9 embodiments also include a step (140) of determining a relation for each of the manufactured features to the fit framework, a step (142) of organizing each of the relations into a single association, and a step (144) of organizing the location of each of the manufactured features relative to the single association. An example of steps 140, 142, and 144 is found in the description of FIGS. 5-7. The FIG. 9 embodiments also include a step (146) of determining a positional error for the manufactured features from the single association. An example of step 146 is found in the description of FIG. 7. The FIG. 9 embodiments also include a step (148) of determining a common region contained within (common to) the organized plurality of manufactured features (organized relative to the single association). An example of step 148 is found in the description of FIG. 7. The FIG. 9 embodiments also include a step (150) of determining a maximum inscribed circle within the common region. An example of step 150 is found in the description of FIG. 7. The FIG. 9 embodiments also include a step (152) of determining the diameter of the maximum inscribed circle. An example of step 152 is found in the description of FIG. 7. The FIG. 9 embodiments also include a step (154) of determining a remaining feature related tolerance from the maximum inscribed circle. An example of step 154 is found in the description of FIG. 7.

FIG. 10 is a diagram illustrating an alignment, employed in some embodiments of the invention, in which a feature such as a hole 100 is evaluated on an individual basis to determine if the feature violates a virtual condition (and thus violates a feature relating tolerance), and if so, how the feature may be modified to avoid such a violation. Hole 100 has a feature surface 102 and a feature center 114. Circle 106 is inscribed within hole 100 with the maximum possible diameter. Virtual condition circle 108 representing the virtual condition may be drawn with a center 112 located at the same center as for the maximum inscribed circle 110 for the pattern. A maximum inscribed circle 110 for the pattern may also be represented. A maximum inscribed circle 110 for the pattern is a circle for the hole 100 that fits in the feature pattern. The feature 102 translation within the pattern is determined by calculating the positional difference between the maximum inscribed circle center 112 and the center 104 of inscribed circle 106 for the hole 100. Inscribing diameter D₃ represents the usable diameter of the hole 100 for a single fastener or mating part to be inserted within the hole 100 without consideration of any other features in the pattern. Diameter D5 represents the usable diameter of the pattern of holes in the part.

Still referring to FIG. 10, the maximum inscribed circle 110 for the pattern is smaller than the virtual condition circle 108, and thus one or more features violate the tolerance requirements of the virtual condition, resulting in interference between the hole and another object such as a fastener or mating part. Feature 102 also violates the virtual condition circle 108, thus also indicating a violation of the tolerance requirements. If the maximum inscribed circle 110 for the pattern is larger than the virtual condition circle 108 and does not intersect it, tolerances are met and there is clearance between the hole and another object such as a fastener or mating part. Causes for feature violations may include, but are not limited to, feature size, pattern translation and feature translation relative to the pattern. The combined total of all the feature violations is the difference between the diameter D₅ of the maximum inscribed circle for the pattern 110 and the diameter D₄ of the virtual condition circle 108.

Feature size and location may be altered to eliminate violations of the virtual condition. Feature size for the hole may be altered by first determining the difference between the minimum tangent radius R1 from center 112 to circle 106 and the virtual condition radius R2. The hole location may be altered along a vector between circle center 104 and the virtual condition center 112.

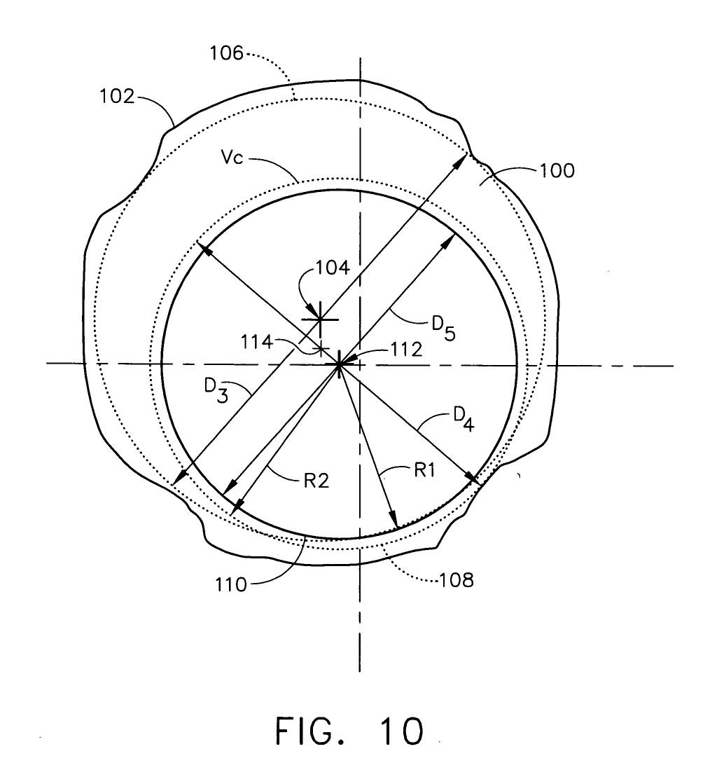

FIG. 11 is a diagram illustrating an alignment, employed in some embodiments of the invention, in which an external feature 200 (to be referred to as a pin) is evaluated on an individual basis to determine if the feature violates the virtual condition, and if so, how the feature may be modified. Pin 200 has a feature surface 202 and a feature center 204. Circle 206 is the circle circumscribed about pin 200 that has the minimum possible diameter. A minimum circumscribing circle 210 (centered at point 214) for the pattern is also determined. Minimum circumscribing circle 210 for the pattern is a circle having minimum radius which circumscribes all manufactured features of the pattern (when they have been organized relative to one true position 212). A virtual condition circle 208 (whose center is also at point 214) representing a virtual condition is also determined. Position 212 of FIG. 11 is a one true position for the pattern (corresponding to one true position 60 of FIG. 7) which is a single association typically determined by superimposing each of transformed true positions of a best fit framework (corresponding to framework 50 of FIG. 6) for the pattern onto each other. The feature 202 translation within the pattern is determined by calculating the positional difference between the one true position 212 and the center 204 of circumscribing circle 206 for the pin 200. The diameter D₆ of the minimum circumscribing circle 206 represents the effective diameter of the pin 200 when inserted within a hole.

Still referring to FIG. 11, the minimum circumscribing circle 210 for the pattern is larger than the virtual condition circle 208, and thus one or more features violate the tolerance requirements of the virtual condition, resulting in interference between the pin 200 and the hole into which the pin 200 will be inserted. Causes for feature violations may include, but are not limited to, feature size, pattern translation and feature translation relative to the pattern. The combined total of all the feature violations is the difference between the diameter D₈ of the minimum circumscribing circle 210 for the pattern and the diameter D₇ of the virtual condition circle 208. Feature size and location may be altered to eliminate violations of the virtual condition. Feature size for pin 200 may be altered by first determining the interference between the pin surface 202 and the virtual condition circle 208. The pin 200 location may be altered by determining the pin location relative to the minimum circumscribing circle for the pattern 210 and then moving the pin location.

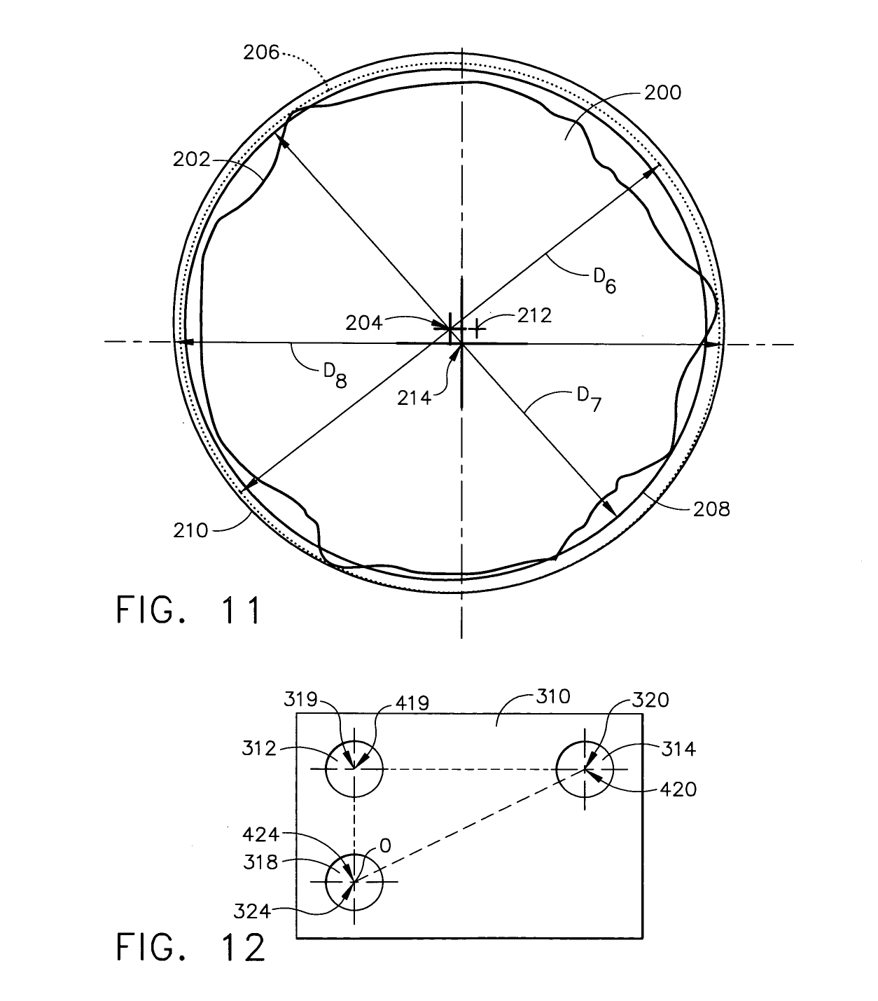

FIG. 12 is a diagram illustrating designed features for an object such as a part. The designed part may be a rectangular plate 310 having features including three spaced-apart circular holes 312, 314, and 318. The holes may have a cross-sectional shape, including but not limited to circular, oval or quadrilateral, but are shown with circular cross-sections in FIG. 12. Each of the designed circular holes 312, 314, 318 has a center, referred to as the true center 319, 320, 324, respectively, and a designed size, referred to as a true size. The designed size may be gauged using the diameter or area of the circle. Each hole 312, 314, 318 has a designed position on plate 310, referred to as a true position. The true centers 319, 320, 324 may be used as the true positions 419, 420, 424, of holes 312, 314, 318, respectively. One of the true centers (e.g., the true center 424 for the bottom left circle 324) may be used as the origin of a Cartesian coordinate system. A computer aided drafting (CAD) system may be used to render the diagram. The design information (including characterizations of circular holes 312, 314, and 318) may be indicated by digital data, which can be stored on a machine-readable medium (e.g., a hard drive or an optical disk) and processed on a computer.

FIG. 13 is a diagram illustrating a manufactured rectangular plate 328, created from the design described with reference to FIG. 12. The manufactured holes 330, 332, and 336 correspond to designed holes 312, 314 and 318. Manufactured rectangular plate 328 may be a simulation of an actually manufactured plate, in which case manufactured holes 330, 332, and 336 are simulated manufactured holes. The simulated holes may be generated to provide a variation analysis model of a rectangular plate. Each manufactured hole 330, 332, 336 has deviated from the true size as well as the true position. A true size deviation may indicate a hole larger or smaller than designed. Each manufactured hole may have a positional error relative to its true position. The positional error may be determined by the distance between the center 338, 340, 344 of each manufactured hole 330, 334, 336 and its true position 419, 420, 424, respectively. The deviations may extend along the depth of each hole. Data regarding the dimensions and position of the manufactured rectangular plate 328 may be acquired by many methods known in the art, including, but not limited to, examining the rectangular plate 328 with a coordinate measuring machine.

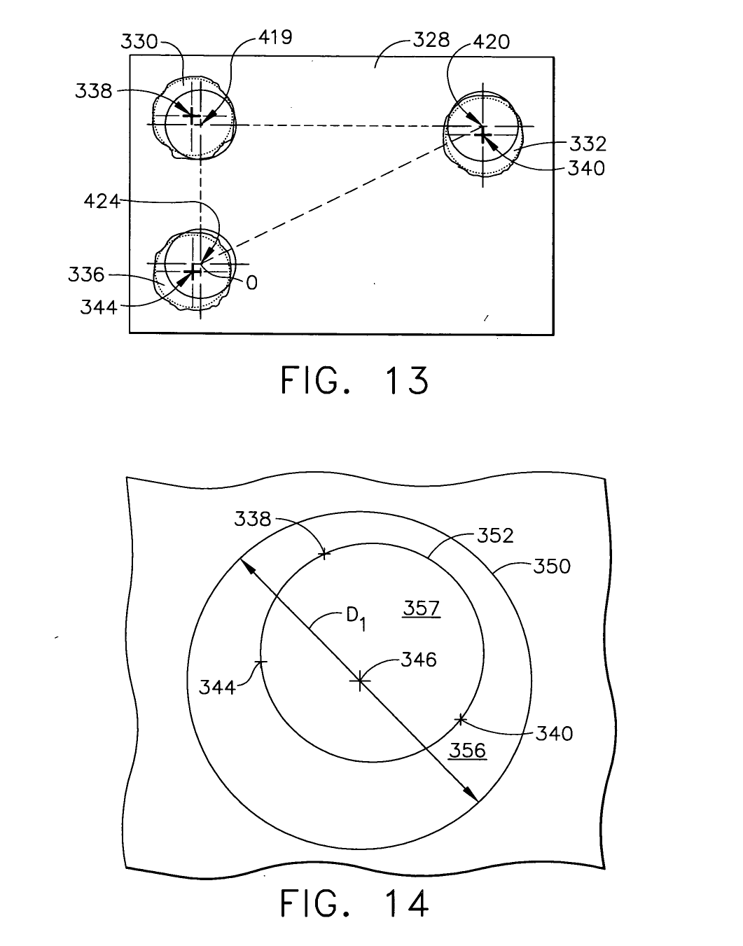

FIG. 14 is a diagram, generated in accordance with some embodiments of the present invention, illustrating the centers 338, 340, 344 of each manufactured hole of FIG. 13 relative to a one true position 346. The one true position 346 represents the true positions of manufactured holes 330, 332, 336 as a single point. The one true position 346 may be a superimposition of true positions 419, 420, 424. Each of centers 338, 340, 344 of the manufactured hole has the same relative position to the one true position 346 as it does to its true position 419, 420, or 424 (FIG. 13), respectively. The one true position 346 may be represented as the arbitrarily-positioned origin of a coordinate system (e.g., an x, y coordinate system), and in this coordinate system the centers 338, 340, 344 of the manufactured holes are determined with respect to the one true position 346.

FIG. 14 also illustrates a circle 350 that represents the pattern locating tolerance zone (PLTZ) whose center is the one true position 346. A PLTZ is a tolerance zone that may be specified in the design data. The PLTZ specifies the positional tolerance for a group of features. In FIG. 14, the diameter D₁ of circle 350 represents the PLTZ. FIG. 14 also shows a feature relating circle 352 that intersects or includes each of the centers 338, 340, 344, positioned as described relative to one true position 346. The feature relating circle 352 indicates a range of how the positions of manufactured holes 330, 332, 336 (FIG. 13) deviate from the one true position 346, and thus, feature relating circle 352 provides an accurate indicator of the deviations of the manufactured holes 330, 332, 336 from the designed pattern. The perimeter of the feature relating circle 352 indicates the maximum deviation of the manufactured holes 330, 332, 336 and the amount of tolerances consumed. Region 356 outside of feature relating circle 352 indicates an allowable positional error relative to the pattern of features that is greater than any of the positional errors of manufactured holes 330, 332, and 336. Should an additional hole center fall within Region 357 that is inside feature relating circle 352, it indicates a positional error relative to the pattern of features that is smaller than the combined positional errors of manufactured holes 330, 332, 336.

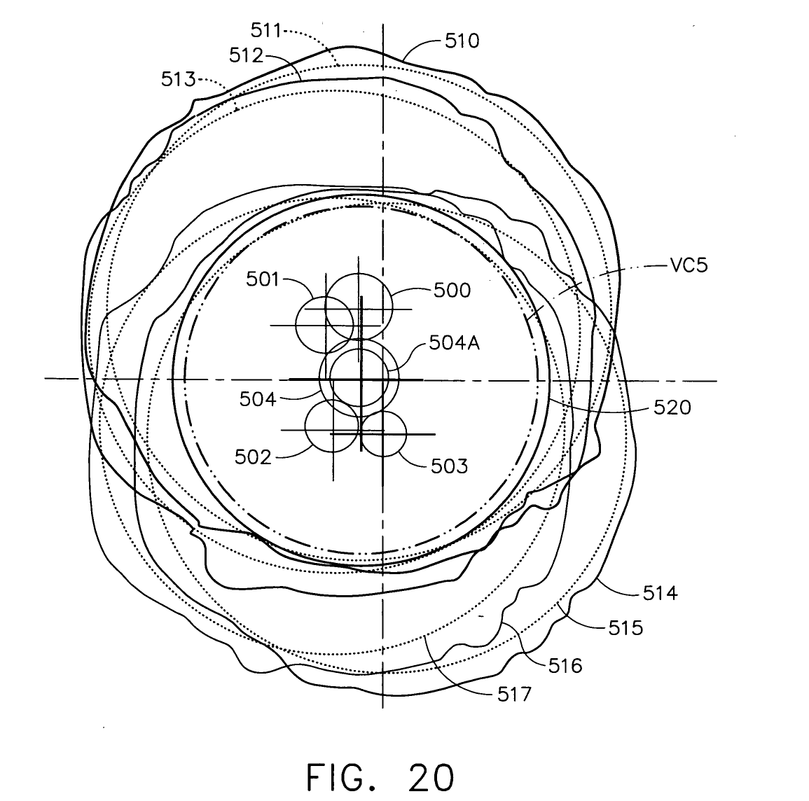

Feature relating figures (e.g., circle 352 of FIG. 14) can be employed in a variety of ways in accordance with various aspects of the present invention, including those described in above-referenced U.S. application Ser. No. 10/800,383 and those described below with reference to FIG. 20.

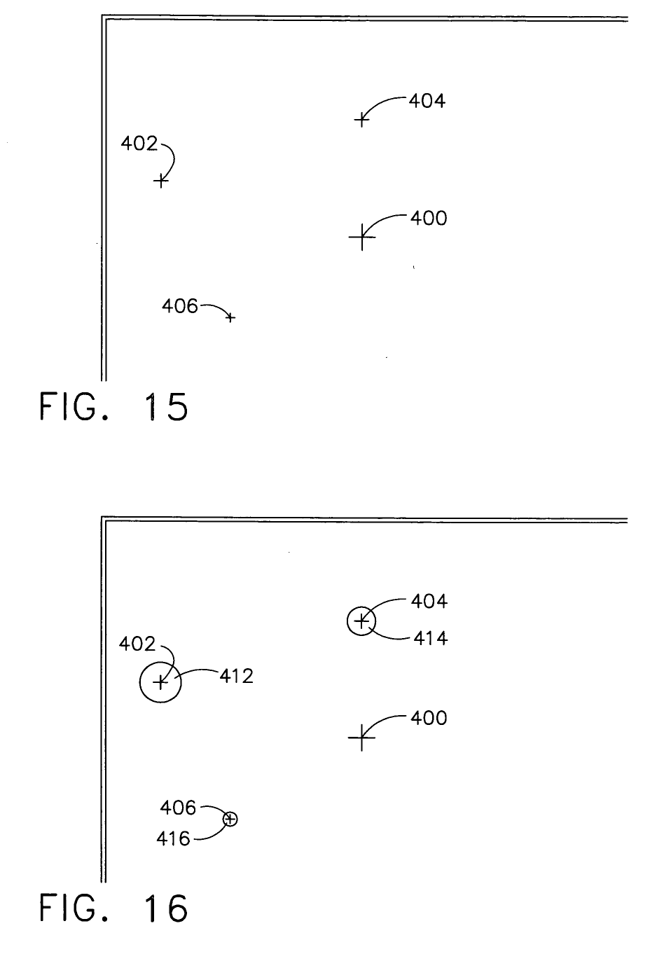

Some embodiments of the present invention determine (and employ pattern constructs indicative of) the used or consumed tolerance for any object having a pattern of features. The following description of FIGS. 15-17 provides an example of such a pattern construct. FIG. 15 is a diagram illustrating manufactured feature centers 402, 404 and 406 of manufactured features (e.g., manufactured holes or other manufactured internal features) of an object (e.g., a rectangular plate) relative to a one true position 400 for the object. The one true position 346 (FIG. 14) corresponds functionally to above-described one true position 346, and may be a superimposition of true positions of the manufactured features.

FIG. 16 is a diagram in which “departure circles” 412, 414 and 416, for feature centers 402, 404 and 406, respectively, represent the size departure of each manufactured feature relative to its true size. The positions of departure circles 412, 414, and 416 relative to one true position 400 indicate a range of deviations of the positions of the manufactured features from their true positions. The diameter of the departure circle for an internal feature (e.g., a hole) may be indicative of the difference in diameter from the minimum hole diameter allowable for the feature in a pattern. The diameter of the departure circle for an external feature (e.g., a pin) may be indicative of the difference in diameter from the maximum allowable diameter for the feature in a pattern.

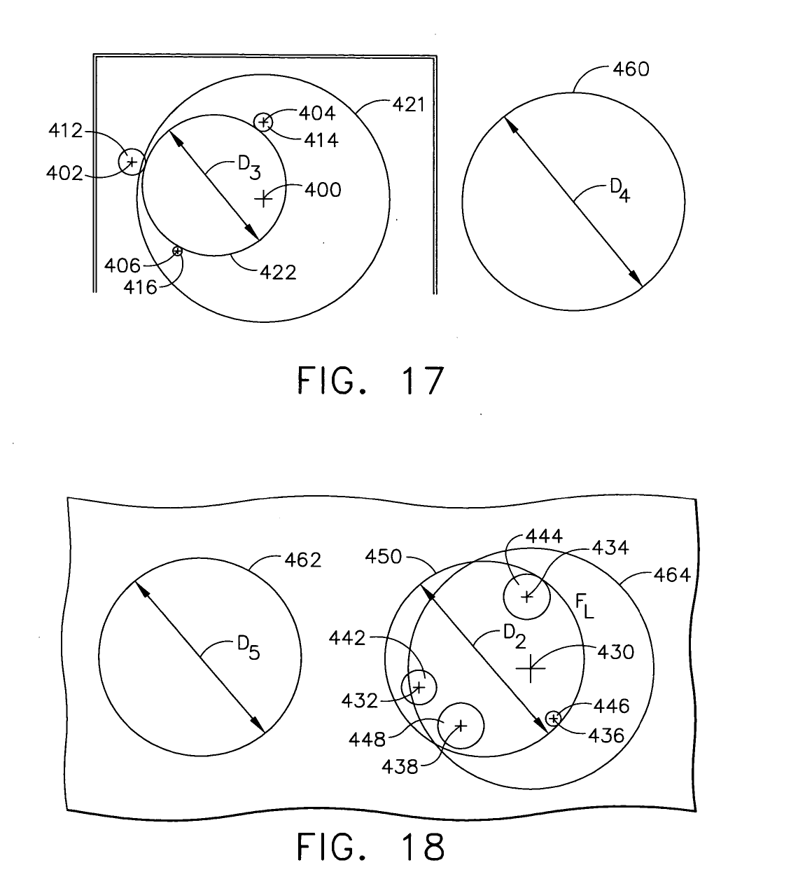

FIG. 17 is a diagram illustrating pattern constructs generated using the FIG. 16 pattern construct, including a PLTZ and a pattern construct indicative of used tolerance for the object indicated by FIG. 16. In FIG. 17, the PLTZ is indicated by the diameter of circle 421, which is centered about the one true position 400. The PLTZ is not violated if the PLTZ circle 421 is tangent to, intersects, or contains the departure circles 412, 414, and 416.

Still referring to FIG. 17, the used tolerance of the holes corresponding to hole centers 402, 404 and 406 may be derived by a used feature relating circle 422 (sometimes referred to herein as a consumed tolerance circle), which is a circle having minimum diameter that is tangent to each departure circle 412, 414 and 416. When a used feature relating circle (e.g., circle 422) is tangent to the near side of each departure circle (e.g., 412, 414 and 416), each departure circle 412, 414 and 416 lies outside of the used feature relating circle. The diameter D₃ of consumed tolerance circle 422 may be compared with the diameter D₄ of an allowable tolerance circle (e.g., allowable tolerance circle 460) that represents allowable feature relating tolerance. If diameter D₃ is greater than diameter D₄ then the pattern of internal features having centers 402, 404 and 406 (and the size departures indicated by FIG. 17) exceeds the allowable tolerances.

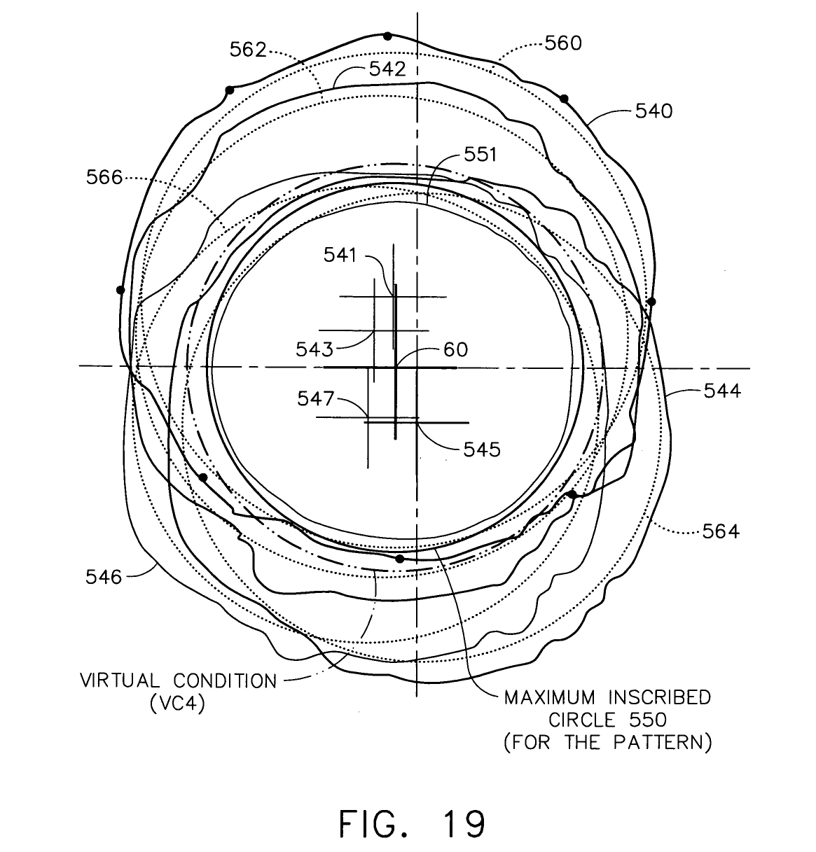

FIG. 18 is a diagram illustrating centers 432, 434, 436, 438 of four manufactured (e.g., simulated) external features (e.g., pins) relative to a one true position 430. The one true position 430 corresponds functionally to above-described one true position 346, and may be a superimposition of true positions of the manufactured features. A departure circle (one of departure circles 442, 444, 446, 448) is defined about the center (432, 434, 436, or 438) of each external feature. Similar to the method described with reference to FIG. 17, a PLTZ may be represented by a PLTZ circle 464 centered about the one true position 430. The PLTZ is not violated if all or a portion of each of the departure circles 442, 444, 446, 448 lies within the PLTZ circle 464.

Still referring to FIG. 18, a used tolerance circle 450 may be drawn that is the smallest circle that contains all of the departure circles 442, 444, 446, 448. Typically, a used tolerance circle (as employed in accordance with some embodiments of the invention) is tangent to the outside of some of the departure circles (as circle 450 is tangent to each of departure circles 442, 444, and 446 in FIG. 18). The diameter D₂ of the used tolerance circle 450 may be compared to with the diameter D₅ of an allowable tolerance circle 462 to determine a remaining allowable tolerance. If the diameter D₂ of the used tolerance circle 450 is smaller than the diameter D₅ of the allowable tolerance circle 462, then the pattern of external features is within the allowable tolerance.

Consumed tolerance figures (e.g., circle 422 of FIG. 17 or circle 450 of FIG. 18) can be employed in a variety of ways in accordance with various aspects of the present invention, including those described in above-referenced U.S. application Ser. No. 10/800,383 and those described below with reference to FIG. 20.

When multiple features of a pattern are produced with size and location variation that are within the allowable positional tolerances, the amount of tolerance used by each of the features may need to be determined. This can be accomplished in accordance with an aspect of the present invention. For example, when two or more parts (each designed to have a pattern of features) are moved relative to each other and the features (e.g., holes in one part, and pins in the other part) are aligned to an optimum position, it is possible that the usable diameter (such as the clear diameter through each of the holes) is not acceptable. In this situation, it is desirable to identify each feature (in one or both of the parts) having error that causes the failure and to determine whether or not each such feature can be modified within the allowable tolerance parameters to make the feature (and pattern of features including the feature) acceptable. Such an identification and determination can be made in accordance with an aspect of the present invention.

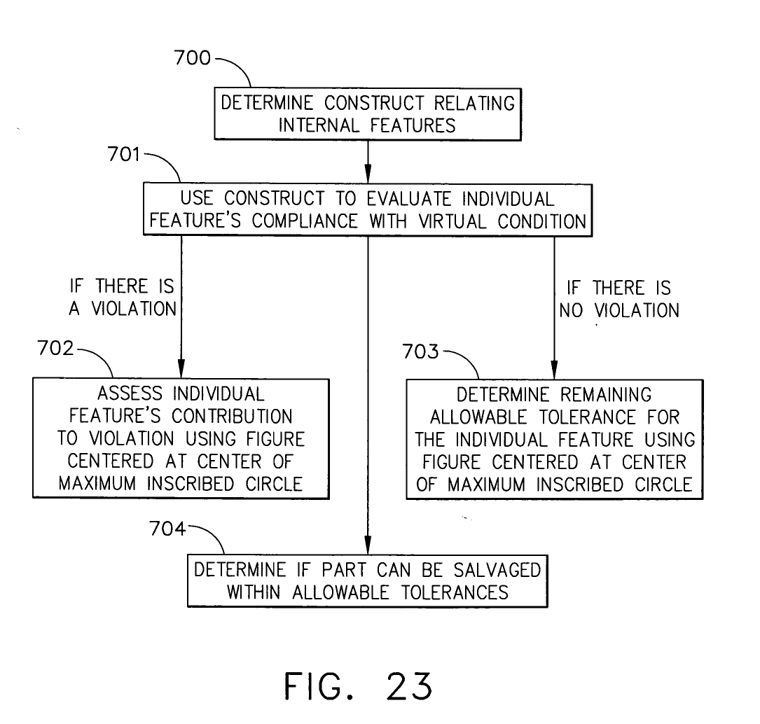

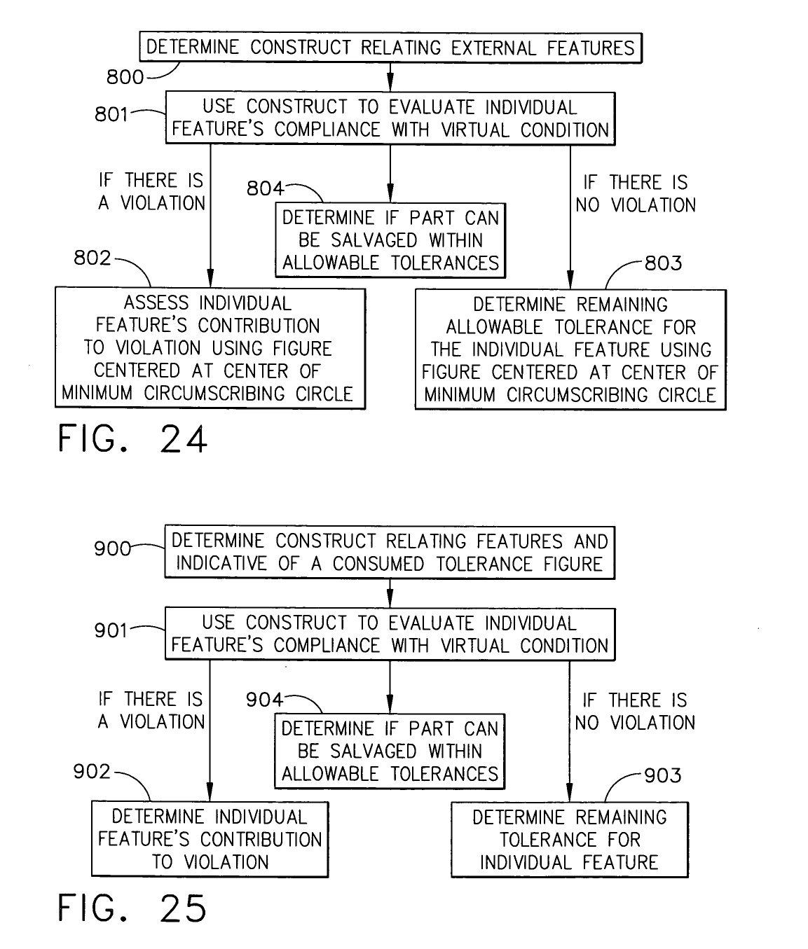

Among the embodiments of the invention are three classes of embodiments for performing feature error assessments (of individual features of a pattern) and determining accommodations: a first class uses point data collected from the surfaces of the features (each method in this class is referred to herein as a “Feature Point Method”); a second class uses measured size of the features and assumes perfect form of the features (each method in this class is referred to herein as a “Feature Shape Method”); and a third class uses feature departure from the maximum material condition (each method in this class is referred to herein as a “Float Consumed Method”). Some embodiments of the Feature Point Method are implemented in accordance with the description below of FIGS. 23 and 24. Some embodiments of the Feature Shape Method are implemented in accordance with the description below of FIGS. 23 and 24. Some embodiments of the Float Consumed Method are implemented in accordance with the description below of FIG. 25. Each of the three classes of embodiments is useful for assessing internal features (holes and other features which cannot cause positional tolerance violations by having size that is too large) and external features (pins and other features which cannot cause positional tolerance violations by having size that is too small). Much of the following description assumes internal features of size, and refers to such internal features as being holes having roughly circular shape. However, this description applies equally well to internal features that are not holes and/or do not have circular (or roughly circular) shape. From the following description of assessment of internal features, it will be apparent to those of ordinary skill in the art how to implement embodiments in which the features under consideration are external features.

We next describe examples of the Feature Point Method which assess individual features of the FIG. 7 pattern construct (e.g., the hole having point P1 on its surface) and the FIG. 11 pattern construct. Then, we consider examples of the Feature Shape Method and Float Consumed Method in which all features meet tolerancing requirements so that there are no tolerance violations.

Above-described FIG. 7 is a pattern construct indicative of shape and position variation for four holes of a pattern. The difference between the diameter D₁ of maximum inscribed circle 62 and the diameter of virtual condition circle VC1 (or virtual condition circle VC2) is a remaining allowable feature relating tolerance for the pattern of holes as a group. The total variation within the pattern of features in this example is within the allowable tolerances indicated by virtual condition circle VC1, since the diameter D₁ of maximum inscribed circle 62 is greater than the diameter of circle VC1. The total variation within the pattern of features in this example exceeds the allowable tolerances indicated by virtual condition circle VC2, since the diameter D₁ of maximum inscribed circle 62 is less than the diameter of circle VC2.

The description of FIG. 7 assumes internal features (holes) which cannot cause tolerance violations by having size that is too large. For pins (and other external features which cannot cause tolerance violations by having size that is too small), tolerance violations and remaining allowable feature tolerances are determined slightly differently. When assessing external features (e.g., pins) using the Feature Point Method, the total variation within a pattern of features is within the allowable tolerances indicated by a virtual condition circle if the diameter of a minimum circumscribing circle (e.g., circle 210 of FIG. 11) is less than the diameter of the virtual condition circle, and the difference between the diameter of the virtual condition circle and the minimum circumscribing circle is a remaining allowable feature relating tolerance for the pattern of features as a group.

In typical implementations of the Feature Point Method, points on feature surfaces are generated or measured, and a maximum inscribed circle (for holes or other “internal” features which cannot cause tolerance violations by having size that is too large) or a minimum circumscribing circle (for pins or other “external” features which cannot cause tolerance violations by having size that is too small) is created for the pattern of features. Each feature is then evaluated relative to the diameter of a virtual condition circle centered at the center of the maximum inscribed circle (e.g., as in FIG. 7) or at the center of the minimum circumscribing circle (e.g., as in FIG. 11). Where there is no tolerance violation, the clearance between the virtual condition and any individual feature surface indicates the remaining allowable tolerance for that feature. More specifically, in cases in which a maximum inscribed circle is employed to assess a pattern of internal features, for each feature the distance from the center of the virtual condition circle to the closest feature point (the point on the feature surface closest to the virtual condition circle, for example, point P1 of FIG. 7) may be determined, and the difference between the point distance (from the center of the virtual condition circle to the point on the feature surface closest to the virtual condition circle) and the radius of the virtual condition circle (the virtual condition circle's radius is necessarily less than the radius of the maximum inscribed circle since the example assumes that there is no tolerance violation) is identified as the remaining allowable tolerance for that single feature at the produced size of the feature. This remaining tolerance combined with any additional allowable size tolerance is the total remaining available tolerance for the feature.

Similarly, in cases in which a minimum circumscribing circle is employed for a pattern of external features, for each feature the distance from the center of the virtual condition circle to the farthest feature point (the point on the feature surface nearest to the virtual condition circle) may be determined, and the difference between the virtual condition circle's radius and the point distance (from the center of the virtual condition circle to the point on the feature surface nearest to the virtual condition circle but farthest from Vc center) is the remaining allowable tolerance for that one feature at the produced size of the feature (the virtual condition circle's radius is necessarily greater than the radius of the minimum circumscribing circle for the pattern since the example assumes that there is no tolerance violation). This remaining tolerance combined with any additional allowable size tolerance is the total remaining available tolerance for the feature.

When multiple features of size are produced with size and location variation that exceeds allowable positional tolerances for one or more of the features, the feature or features that cause the violation typically must be identified. In general, determination in accordance with an aspect of the invention that the surface of any feature violates a virtual condition indicates a violation of the allowable tolerances for that feature. Once a violation causing feature is identified, it is typically important to determine whether or not the feature can be modified within the allowable tolerance parameters to make the pattern (which includes the feature) acceptable. The Feature Point Method can be employed to make such determinations. For example, in the embodiments described in the two preceding paragraphs, the condition that a maximum inscribed circle diameter for the pattern is smaller than the virtual condition circle diameter indicates that at least one internal feature violates the allowable tolerances. In cases in which a tolerance violation exists, a process of the type described in either of the two previous paragraphs can be performed to determine the magnitude of the violation of the allowable tolerance of each individual feature of the pattern that causes the violation for the pattern as a whole. For example, assuming that a pattern construction including a maximum inscribed circle has been determined in accordance with an aspect of the invention for a pattern of internal features, the distance from the center of a virtual condition circle to the farthest feature point (the point on the feature surface farthest inside the virtual condition circle) can be determined for each feature, and the difference between the radius of the virtual condition circle and the point distance (from the center of the virtual condition circle to the point on the feature surface farthest inside the virtual condition circle) is identified as the magnitude of the violation for the feature under consideration (the virtual condition circle's radius is necessarily greater than the radius of the maximum inscribed circle in this example, since the example assumes a tolerance violation).

In typical implementations of the Feature Point Method, each feature is evaluated relative to a virtual condition (e.g., the size of a virtual condition circle) centered on a maximum inscribed circle (or minimum circumscribing circle) for the pattern. For example, for a hole or other internal feature of a pattern having a tolerancing violation, the distance from the center of a virtual condition circle to the closest point on each feature surface may be determined, and a violation of tolerance requirements for a feature is indicated by the distance being less than the radius of the virtual condition circle. For each feature for which a violation exists, the difference between the point distance (distance from the virtual condition circle center to the closest point on the surface of the relevant feature) and the radius of the virtual condition can be identified as the magnitude of violation of the allowable tolerance for the feature.

FIG. 19 is a pattern construct indicative of shape and position variation for four holes (holes 540, 542, 544, and 546) of a pattern. The holes have been aligned with respect to a one true position in accordance with an aspect of the invention. The one true position can be determined in the same manner as is the one true position of the pattern construct described with reference to FIG. 7. As aligned with respect to the one true position, point 541 is the center of hole 540, point 543 is the center of hole 542, point 545 is the center of hole 544, and point 547 is the center of hole 546. Circle 550 is a maximum inscribed circle for the pattern (the circle having maximum diameter inscribed within all of the aligned holes). Virtual condition circle VC4 (centered at the center of circle 550) has a diameter indicative of an allowable feature relating tolerance for the pattern of holes.

In the FIG. 19 pattern construct, holes 540, 544, and 546 violate the virtual condition since the distance from the center of virtual condition circle VC4 to the closest point on the surface of each of holes 540, 544, and 546 is less than the radius of circle VC4. The magnitude of each such violation may be determined in accordance with an aspect of the invention and used to determine if the feature can be reworked to achieve compliance for the pattern. The size of the feature and its position may be modified up to the full extent of the applicable tolerances.

For example, consider the case that the hole having shape 540 (in FIG. 19) and virtual condition circle VC4 (of FIG. 19) satisfy the following:

specified hole diameter: 1.260 plus 0.012 and minus 0.000;

feature relating position tolerance of diameter 0.010 at MMC;

virtual condition (diameter of circle VC4) is 1.260−0.010=1.250, so that the radius of VC4 is 0.625;

maximum measured hole size (across the hole) is 1.262;

measured point distance (distance from the center of circle VC4 to the closest point on the surface of hole 540) is 0.622; and

the magnitude of the requirements violation is 0.625 (virtual condition radius)−0.622 (measured point distance)=0.003.

In this example, if the hole size (diameter) is increased by 0.006, so that the modified hole diameter is 1.268, and the location remains the same, the point distance (distance from the center of circle VC4 to the closest point on the surface of the modified hole 540) will increase to 0.625, resulting in no violation of requirements for the modified hole.

In accordance with typical embodiments of the invention (including typical embodiments of the Feature Point Method or the Feature Shape Method), the following operations can easily be performed during variation analysis:

1. the number (or percentage) of part or assembly failures caused by process capability can be determined;

2. the number (or percentage) of part or assembly failures that can be reworked within specified tolerances can be determined;

3. the number (or percentage) of part or assembly failures that cannot be reworked can be determined; and/or

4. the magnitude of excessive variation for each feature can be determined.

In accordance with typical embodiments of the invention (including typical embodiments of the Feature Point Method or the Feature Shape Method), the following operations can easily performed during produced part assessment:

1. the specific features that fail the feature relating tolerance requirement can be determined and the magnitude of each failure can be determined; and/or

2. the required rework for each of the discrepant features can be determined.

We next describe examples of the Feature Shape Method. When implementing typical examples of the Feature Shape Method, shapes of perfect form (e.g., circles, for manufactured holes and pins designed to have circular form but which may deviate from such ideal or “true” circular shape) are used to represent feature locations and size. If any feature form error is present, such use of shapes of perfect form can introduce errors in accuracy of results. The amount of error is dependent on the amount of form error. In many cases the error that is introduced by use of shapes of perfect form is small and the user may determine it to be insignificant.

When implementing typical examples of the Feature Shape Method, figures are employed to represent manufactured features. These figures (sometimes referred to herein as “feature figures” of or having “true shape”) have shapes of perfect form in the sense that their shapes match the true (designed) shapes of the manufactured features. The size of each feature figure of true shape can deviate from the designed size of the manufactured feature it represents.

The size (e.g., diameter) of each feature figure of true shape may be determined by any means, for example by determining a best-fit circle or maximum inscribed circle for each feature. For example, in FIG. 19, circle 560 is used to indicate the hole having surface 540, circle 562 is used to indicate the hole having surface 542, circle 564 is used to indicate the hole having surface 544, and circle 566 is used to indicate the hole having surface 546. For a pattern of holes, a pattern construct indicative of positional errors of the holes may be determined (e.g., the pattern construct of above-described FIG. 8 or that of FIG. 19) using the circles representing the holes of the pattern, and a maximum inscribed circle (e.g., circle 80 of FIG. 8 or circle 551 of FIG. 19) for the feature-indicating circles may be determined from the pattern construct. In FIG. 19, circle 550 is the circle having maximum radius that is inscribed within surfaces 540, 542, 544, and 546, and reference numeral 551 represents the circle having maximum radius that is inscribed within circles 560, 562, 564, and 566. Circle 551 is shown with slightly smaller diameter than it would actually have, in order to show it as a circle distinct from maximum inscribed circle 550 (if circle 551 were shown with correct diameter, it would be too close to circle 550 to be distinguishable from circle 550). In FIG. 19, surface form errors are such that maximum inscribed circle 551 does not touch any of the feature surfaces, but it is tangent to several of the feature-indicating circles (e.g., circles 564 and 566) that represent the features. Maximum inscribed circle 551 in the FIG. 19 example is smaller than the maximum inscribed circle (circle 550 of FIG. 19) established by the Feature Point Method for the same pattern.

With reference to FIG. 8, in an example of the Feature Shape Method, for each feature, the minimum distance from the virtual condition center (e.g., the center of virtual condition circle VC3) to the feature-indicating circle for the feature (inscribed circle 70, 72, 74, or 76) is determined. Circle VC3 is concentric with circle 80 in FIG. 8. The difference between this minimum distance (e.g., the minimum distance between circle 70 and the center of circle VC3 in FIG. 8) and the radius of the virtual condition circle is the remaining allowable tolerance for the relevant feature (i.e., feature 30, in which circle 70 is inscribed) when it is at the produced size of that feature. This remaining allowable tolerance combined with any additional allowable size tolerance for the feature is the total remaining tolerance available for the feature. Should the feature variations exceed the allowable tolerance, the same steps are performed, but the result will indicate the magnitude of the violation of the allowable tolerance.

In another example of the Feature Shape Method to be described with reference to FIG. 19, for each feature, the minimum distance from the virtual condition center (the center of virtual condition circle VC4) to the feature-indicating circle for the feature (e.g., the minimum distance from the center of circle VC4 to the inscribed circle 560, for the feature having surface 540) is determined. The fact that virtual condition circle VC4 has diameter greater than maximum inscribed circle 551 in FIG. 19 indicates a violation of allowable tolerance for the pattern. The difference between the minimum distance for each feature (from the virtual condition center to the feature-indicating circle for the feature) and the virtual condition radius is the violation of allowable tolerance for the feature at its produced size. This violation of allowable tolerance may be accommodated if there is any remaining allowable size tolerance for the feature.

We next describe examples of the Float Consumed Method with reference to FIG. 20. These examples assume a pattern of features (e.g., holes) having surfaces 510, 512, 514, and 516. In the same manner as described above with reference to FIGS. 15-17, a pattern construct (represented by FIG. 20) is generated in which the location of each feature may be determined relative to a common true position (a one true position) and each feature is located relative to the common true position. The common true position can be a superposition of the centers of the features. In FIG. 20, circles 511, 513, 515, and 517 are maximum inscribed circles within surfaces 510, 512, 514, and 516, respectively. The diameter of each feature may be determined and the departure of the feature from a MMC may be calculated to generate a departure circle for the feature (e.g., in the same way that departure circles 412, 414, and 416 of FIGS. 16-17 are generated).

In FIG. 20, departure circle 500 is the departure circle for the feature having surface 510, departure circle 501 is the departure circle for the feature having surface 512, departure circle 502 is the departure circle for the feature having surface 515, and departure circle 503 is the departure circle for the feature having surface 514. The diameter of each departure circle represents the size departure of the manufactured feature relative to its true (ideal) size. Each departure circle is centered at the center (in the FIG. 20 pattern construct) of the feature to which it pertains. The positions of departure circles 500, 501, 502, and 503 relative to the one true position indicate a range of deviations of the positions of the manufactured features from their true positions.

Using the FIG. 20 pattern construct, the used tolerance of the features having shapes 510, 512, 514, and 516 may be derived by determining a used feature relating circle (sometimes referred to herein as a consumed tolerance circle), which is a circle having minimum diameter that is tangent to at least two of the departure circles (e.g., departure circles 500, 501, 502, and 503) and includes or intersects all other ones of the departure circles. Consumed tolerance circle 504 is the smallest circle that is tangent to two or more of departure circles 500, 501, 502, and 503 and includes or intersects all remaining ones of departure circles 500, 501, 502, and 503. Circle 504 has a diameter equal to the tolerance consumed by the pattern. Circle 520 is a maximum inscribed circle (inscribed within inscribed circles 511, 513, 515, and 517), and VC5 is a virtual condition circle centered at the center of circle 520.

Any feature whose departure circle is contained within or intersected by the consumed tolerance circle has consumed less tolerance than indicated by the consumed tolerance circle. The actual tolerance consumed for an individual feature can be determined in accordance with an aspect of the invention by determining (and typically generating data indicative of) the diameter of the smallest circle that is concentric with the consumed tolerance circle and tangent to the departure circle for the feature. The total remaining tolerance for that feature can be found by subtracting the actual consumed tolerance from the sum of the allowable position tolerance and the allowable size tolerances.

For example, in FIG. 20, the smallest circle that is concentric with consumed tolerance circle 504 and tangent to departure circle 502 is indicative of the actual tolerance consumed by the individual feature having surface 516. The total remaining tolerance for that feature can be found by subtracting the diameter of such smallest circle (which is concentric with consumed tolerance circle and tangent to departure circle for the feature) from the sum of the allowable position tolerance and the allowable size tolerances.

If the tolerance consumed by the pattern is greater than the allowed tolerance, then individual features may be evaluated in accordance with the Float Consumed Method to determine the amount of violation for each feature. This is accomplished by generating an allowed tolerance circle that is centered on the original consumed tolerance circle but has a radius equal to the allowable tolerance diameter (this is a smaller radius than that of the original consumed tolerance circle). For example, the allowable consumed tolerance circle 504A of FIG. 20 is the reduced diameter consumed tolerance circle for the pattern. The clearance between the reduced diameter consumed tolerance circle 504A and departure circle for each feature may be determined. The clearance value for each feature is identified as the radial violation associated with the feature.

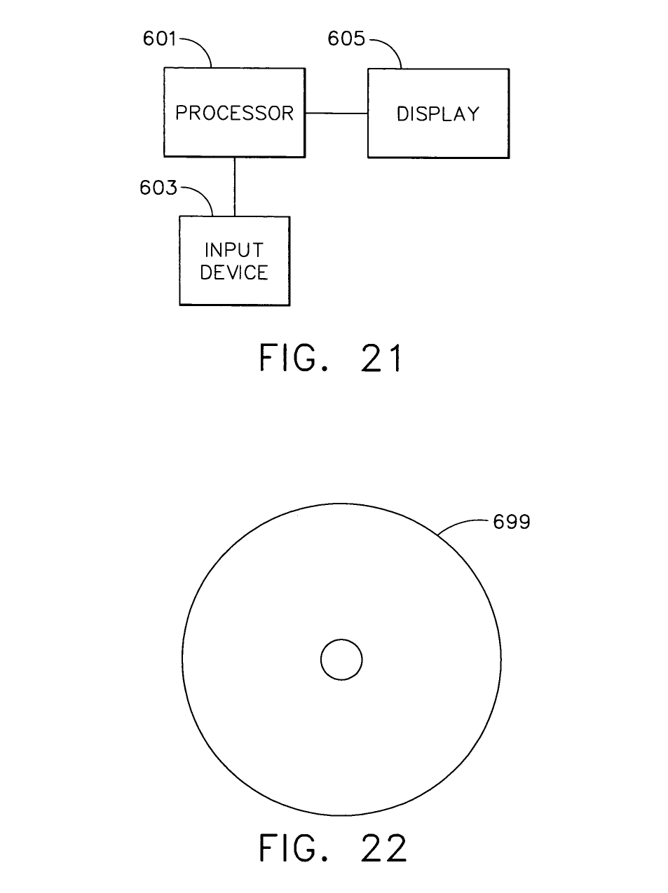

The computer system of FIG. 21 includes processor 601, input device 603 coupled to processor 601, and display device 605 coupled to processor 601. Processor 601 is programmed to implement the inventive method in response to instructions and data entered by user manipulation of input device 603. Computer readable optical disk 699 of FIG. 22 has computer code stored thereon. This code is suitable for programming processor 601 to implement an embodiment of the inventive method.

FIG. 23 is a flowchart of steps performed in some embodiments of the inventive method for evaluating compliance of an individual feature of a pattern of internal features with a virtual condition. A pattern construct indicative of relative positions of the features may be determined (step 700). This can be done, for example, in the manner described above with reference to FIG. 7 or 19 (e.g., the pattern construct of FIG. 19 is indicative of relative positions of internal features indicated by FIGS. 540, 542, 544, and 546). The pattern construct may be indicative of at least one of remaining allowable tolerance of the pattern and consumed tolerance of the pattern, and may include a maximum inscribed circle which is inscribed within feature figures (e.g., circle 550 of FIG. 19 which is inscribed within FIGS. 540, 542, 544, and 546, or circle 551 of FIG. 19 which is inscribed within FIGS. 560, 562, 564, and 566). The feature figures (e.g., FIGS. 540, 542, 544, and 546, or FIGS. 560, 562, 564, and 566) may be indicative of all the features in relative positions determined by the pattern construct.

The pattern construct may be used (step 701) to evaluate compliance of the individual feature with the virtual condition, including by determining from the maximum inscribed circle and the virtual condition whether the pattern violates a set of allowable feature relating tolerances (e.g., as any of the feature figures of FIG. 19 can be used with virtual condition circle VC4 to evaluate compliance of the individual feature represented by such feature figure with the virtual condition).

If step 701 determines that there is a violation of the set of allowable feature relating tolerances, step 702 is performed to assess the individual feature's contribution to the violation. This can be done using data indicative of the shape of the individual feature and data indicative of a virtual condition figure centered at the center of the maximum inscribed circle. For example, this can be done by determining the difference between the virtual condition figure's radius (e.g., the radius of circle VC4 of FIG. 19), and the distance between the center of the maximum inscribed circle and a point on the feature figure for the individual feature (e.g., feature 540 of FIG. 19) that is nearest to the maximum inscribed circle's center. If step 701 determines that there is no violation of the set of allowable feature relating tolerances, step 703 is performed to determine a remaining allowable tolerance of the individual feature. This can be done using data indicative of the shape of the individual feature and data indicative of a virtual condition figure centered at the center of the maximum inscribed circle. For example, this can be done by determining the difference between the virtual condition figure and a feature figure for the individual feature as described above.

Optionally, step 704 is also performed (after step 701) to determine if the individual feature can be reworked within allowable limits (e.g., to determine whether a part having the pattern of features can be salvaged).

FIG. 24 is a flowchart of steps performed in some other embodiments of the inventive method for evaluating compliance of an individual feature of a pattern of external features with a virtual condition. A pattern construct indicative of relative positions of the features may be determined (step 800). This can be done, for example, in the manner described above with reference to FIG. 11 (the pattern construct of FIG. 11 is indicative of relative positions of external features, including the external feature indicated by feature 202). The pattern construct may be indicative of at least one of remaining allowable tolerance of the pattern and consumed tolerance of the pattern, and may include a minimum circumscribing circle which circumscribes feature figures (e.g., circle 210 of FIG. 11, which inscribes figures including FIG. 202). The feature figures may be indicative of all the features in relative positions determined by the pattern construct.

The pattern construct may be used (step 801) to evaluate compliance of the individual feature with the virtual condition, including by determining from the minimum circumscribing circle and the virtual condition whether the pattern violates a set of allowable feature relating tolerances (e.g., as feature FIG. 202 of FIG. 11 can be used, with a virtual condition circle having size indicative of such tolerances and centered at the center of minimum circumscribing circle 210, to evaluate compliance of the individual feature represented by such feature figure with the virtual condition).

If step 801 determines that there is a violation of the set of allowable feature relating tolerances, step 802 is performed to assess the individual feature's contribution to the violation. This can be done using data indicative of the shape of the individual feature and data indicative of a virtual condition figure centered at the center of the minimum circumscribing circle (e.g., data indicative of feature FIG. 202 of FIG. 11 and data indicative of a virtual condition circle centered at the center of minimum circumscribing circle 210 of FIG. 11). If step 801 determines that there is no violation of the set of allowable feature relating tolerances, step 803 is performed to determine a remaining allowable tolerance of the individual feature. This can be done using data indicative of the shape of the individual feature and data indicative of a virtual condition figure centered at the center of the minimum circumscribing circle. For example, this can be done by determining a minimum distance between the virtual condition figure's radius and a point on the feature figure for the individual feature that is farthest from the center of the minimum circumscribing circle.

Optionally, step 804 is also performed (after step 801) to determine if the individual feature can be reworked within allowable limits (e.g., to determine whether a part having the pattern of features can be salvaged).

FIG. 25 is a flowchart of steps performed in some other embodiments of the inventive method for evaluating compliance of an individual feature of a pattern of external features with a virtual condition. A pattern construct indicative of relative positions of the features may be determined (step 900). This can be done, for example, in the manner described above with reference to FIG. 20 (e.g., the pattern construct of FIG. 20 is indicative of relative positions of internal features indicated by FIGS. 510, 512, 514, and 551, or by FIGS. 511, 513, 515, and 517). The pattern construct may be indicative of consumed tolerance of the pattern, typically by including data indicative of a consumed tolerance figure (e.g., consumed tolerance circle 504 of FIG. 20).

The consumed tolerance figure can be a consumed tolerance circle determined during step 900 as follows. Departure figures (e.g., departure circles 500, 501, 502 and 503 of FIG. 20) are determined, including a departure figure for each of the features. Each departure figure has a size (e.g., diameter) indicative of size departure of one of the features relative to a true size for such feature. Each departure figure has a position determined by the pattern construct. The consumed tolerance figure may be determined from the departure figures (e.g., in the manner that consumed tolerance circle 504 of FIG. 20 may be determined, as explained above with reference to FIG. 20).

The pattern construct may be used (step 901) to evaluate compliance of the individual feature with the virtual condition. This can be accomplished by determining actual tolerance consumed by the individual feature. The actual tolerance consumed by the individual feature can be determined by determining a diameter of a smallest circle that is concentric with the consumed tolerance circle and tangent to the departure circle for the individual feature being assessed. The actual tolerance consumed by the individual feature may then be determined from the diameter of such a smallest circle (e.g., as explained above with reference to FIG. 20).

If step 901 determines that there is no violation of the set of allowable feature relating tolerances, step 903 is performed to determine a total remaining tolerance for the individual feature. This can be done by subtracting the actual tolerance consumed by the individual feature from a sum of allowable feature tolerances. If step 901 determines that there is a violation of the set of allowable feature relating tolerances (e.g., if the consumed tolerance of the pattern exceeds an allowed tolerance determined by the combined feature relating tolerances and produced feature sizes), step 902 is performed to determine an amount of tolerance violation for the individual feature. This can be done by determining a smaller consumed tolerance figure (e.g., consumed tolerance circle 504A of FIG. 20) that is concentric with the consumed tolerance figure determined in step 900 but has size (e.g., diameter) indicative of an allowable tolerance diameter, and determining an amount of clearance between the smaller consumed tolerance figure the departure figure (e.g., one of departure circles 500, 501, 502, and 503 of FIG. 20) for the individual feature.

Optionally, step 904 is also performed (after step 901) to determine if the individual feature can be reworked within allowable limits (e.g., to determine whether a part having the pattern of features can be salvaged).

It should be understood, of course, that the foregoing relates to exemplary embodiments of the invention and that modifications may be made without departing from the spirit and scope of the invention as set forth in the following claims.

1. A method for evaluating compliance of an individual feature of a pattern of features with a virtual condition, including the steps of:
(a) determining, from data indicative of the pattern, a pattern construct that is indicative of relative positions of the features and is also indicative of at least one of remaining allowable tolerance of the pattern and consumed tolerance of the pattern; and
(b) using the pattern construct to evaluate compliance of the individual feature with the virtual condition.

2. The method of claim 1, wherein the virtual condition is indicative of feature tolerance requirements, and also including the step of:
using the pattern construct to determine whether the individual feature violates the virtual condition and thus violates at least one of the feature tolerance requirements.

3. The method of claim 2, wherein the individual feature violates the virtual condition, and said method also includes the step of:
determining a modified version of the individual feature, and a modified version of the pattern including the modified version of the individual feature in place of the individual feature, such that the modified version of the pattern does not violate the feature tolerance requirements.

4. The method of claim 1, wherein the pattern construct is indicative of consumed tolerance of the pattern, and step (a) includes the steps of:
determining departure figures, including a departure figure for each of the features, wherein each said departure figure has a size indicative of size departure of one of the features relative to a true size for said one of the features, and each said departure figure has a position determined by the pattern construct; and
determining from the departure figures a consumed tolerance figure indicative of the consumed tolerance of the pattern.

5. The method of claim 4, wherein the departure figures are departure circles, the consumed tolerance figure is a consumed tolerance circle, and relative positions of the departure circles are indicative of a range of deviations of the positions of the features from true positions of said features.

6. The method of claim 5, wherein the features are internal features, and each of the departure circles has a diameter indicative of the difference between a size of one of the features and a minimum allowable diameter allowable for said one of the features.

7. The method of claim 4, including the step of determining actual tolerance consumed by the individual feature.

8. The method of claim 7, wherein the departure figures are departure circles, the consumed tolerance figure is a consumed tolerance circle, and the actual tolerance consumed by the individual feature is determined by:
determining a diameter of a smallest circle that is concentric with the consumed tolerance circle and tangent to the departure circle for said individual feature, and determining the actual tolerance consumed by the individual feature from the diameter of said smallest circle.

9. The method of claim 7, also including the step of determining total remaining tolerance for the individual feature.

10. The method of claim 9, wherein the total remaining tolerance for the individual feature is determined by subtracting the actual tolerance consumed by the individual feature from a sum of allowable feature relating tolerances.

11. The method of claim 4, wherein the consumed tolerance of the pattern exceeds an allowed tolerance determined by a combination of position and size tolerance, said method also including the step:
determining an amount of tolerance violation for the individual feature.

12. The method of claim 11, wherein the amount of tolerance violation for the individual feature is determined by:
determining a smaller consumed tolerance figure that is concentric with the consumed tolerance figure but has size indicative of an allowable tolerance diameter determined by a feature relating tolerance and the size tolerance; and
determining an amount of clearance between the smaller consumed tolerance figure the departure figure for the individual feature.

13. The method of claim 1, wherein the features are internal features, the pattern construct includes a maximum inscribed circle which is inscribed within feature figures indicative of all the features, the feature figures have relative positions determined by the pattern construct, and step (b) includes the step of:
determining from the maximum inscribed circle and the virtual condition whether the pattern violates a set of allowable feature relating tolerances.

14. The method of claim 13, wherein the individual feature has a shape and the maximum inscribed circle has a center, said method also including the step of:
(c) assessing the individual feature's contribution to a violation of the set of allowable feature relating tolerances, using data indicative of the shape of the individual feature and data indicative of a virtual condition figure centered at the center of the maximum inscribed circle.

15. The method of claim 1, wherein the features are internal features having true shapes, the pattern construct includes a maximum inscribed circle which is inscribed within feature figures having relative positions determined by the pattern construct, each of the feature figures is indicative of a size and a true shape of one of the features, and step (b) includes the step of:
determining from the maximum inscribed circle and the virtual condition whether the pattern violates a set of allowable feature relating tolerances.

16. The method of claim 15, wherein the individual feature has a size and a true shape, and the maximum inscribed circle has a center, said method also including the step of:
(c) assessing the individual feature's contribution to a violation of the set of allowable feature relating tolerances, using data indicative of a figure having the true shape of the individual feature and the size of the individual feature, and data indicative of a virtual condition figure centered at the center of the maximum inscribed circle.

17. The method of claim 1, wherein the features are external features, the pattern construct includes a minimum circumscribing circle which circumscribes feature figures indicative of all the features, the feature figures have relative positions determined by the pattern construct, and step (b) includes the step of:
determining from the minimum circumscribing circle and the virtual condition whether the pattern violates a set of allowable feature relating tolerances.

18. The method of claim 17, wherein the individual feature has a shape and the minimum circumscribing circle has a center, said method also including the step of:
(c) assessing the individual feature's contribution to a violation of the set of allowable feature relating tolerances, using data indicative of the shape of the individual feature and data indicative of a virtual condition figure centered at the center of the minimum circumscribing circle.

19. The method of claim 1, wherein the features are external features having true shapes, the pattern construct includes a minimum circumscribing circle which circumscribes feature figures having relative positions determined by the pattern construct, each of the feature figures is indicative of a size and a true shape of one of the features, and step (b) includes the step of:
determining from the minimum circumscribing circle and the virtual condition whether the pattern violates a set of allowable feature relating tolerances.

20. The method of claim 19, wherein the individual feature has a size and a true shape, and the minimum circumscribing circle has a center, said method also including the step of:
(c) assessing the individual feature's contribution to a violation of the set of allowable feature relating tolerances, using data indicative of a figure having the true shape of the individual feature and the size of the individual feature, and data indicative of a virtual condition figure centered at the center of the minimum circumscribing circle.

21. A method for evaluating compliance of an individual feature of a pattern of internal features with a virtual condition, including the steps of:
(a) determining, from data indicative of the pattern, a pattern construct that is indicative of relative positions of the features and is also indicative of at least one of remaining allowable tolerance of the pattern and consumed tolerance of the pattern, wherein the pattern construct includes a maximum inscribed circle which is inscribed within feature figures indicative of all the features in relative positions determined by the pattern construct; and
(b) using the pattern construct to evaluate compliance of the individual feature with the virtual condition, including by determining from the maximum inscribed circle and the virtual condition whether the pattern violates a set of allowable feature tolerances.

22. The method of claim 21, wherein the individual feature has a shape and the maximum inscribed circle has a center, said method also including the step of:
(c) assessing the individual feature's contribution to a violation of the set of allowable feature tolerances, using data indicative of the shape of the individual feature and data indicative of a virtual condition figure centered at the center of the maximum inscribed circle.

23. The method of claim 22, wherein the feature figures are indicative of shapes of all the features and have relative positions determined by the pattern construct.

24. The method of claim 22, wherein step (b) includes a determination of a violation by the pattern of the set of allowable feature tolerances, the feature figures include a feature figure for the individual feature, the virtual condition figure has a radius, and step (c) includes the step of:
determining a difference between the virtual condition figure's radius and a distance between the maximum inscribed circle's center and a point on the feature figure for the individual feature that is nearest to the maximum inscribed circle's center.

25. The method of claim 21, wherein the individual feature has a shape and the maximum inscribed circle has a center, said method also including the step of:
(c) determining a remaining allowable tolerance of the individual feature using data indicative of the shape of the individual feature and data indicative of a virtual condition figure centered at the center of the maximum inscribed circle.

26. The method of claim 25, wherein the feature figures are indicative of shapes of all the features and have relative positions determined by the pattern construct.

27. The method of claim 26, wherein the feature figures include a feature figure for the individual feature, and step (c) includes the step of:
determining minimum clearance between the virtual condition figure and the feature figure for the individual feature.

28. The method of claim 21, wherein the individual feature has a size and a true shape and the maximum inscribed circle has a center, said method also including the step of:
(c) assessing individual feature's contribution to a violation of the set of allowable feature tolerances, using data indicative of a figure having the true shape of the individual feature and the size of the individual feature, and data indicative of a virtual condition figure centered at the center of the maximum inscribed circle.

29. The method of claim 28, wherein the features have true shapes, the feature figures have shapes indicative of the true shapes and relative positions determined by the pattern construct, and each of the feature figures is indicative of a size of one of the features.

30. The method of claim 28, wherein step (b) includes a determination of a violation by the pattern of the set of allowable feature tolerances, the feature figures include a feature figure for the individual feature, the virtual condition figure has a radius, and step (c) includes the step of:
determining a difference between the virtual condition figure's radius and a distance between the maximum inscribed circle's center and a point on the feature figure for the individual feature that is nearest to the maximum inscribed circle's center.

31. The method of claim 21, wherein the individual feature has a size and a true shape and the maximum inscribed circle has a center, said method also including the step of:
(c) determining a remaining allowable tolerance of the individual feature using data indicative of a figure having the true shape of the individual feature and the size of the individual feature, and data indicative of a virtual condition figure centered at the center of the maximum inscribed circle.

32. The method of claim 31, wherein the features have true shapes, the feature figures have shapes indicative of the true shapes and relative positions determined by the pattern construct, and each of the feature figures is indicative of a size of one of the features.

33. The method of claim 31, wherein the feature figures include a feature figure for the individual feature, and step (c) includes the step of:
determining minimum clearance between the virtual condition figure and the feature figure for the individual feature.

34. A method for evaluating compliance of an individual feature of a pattern of external features with a virtual condition, including the steps of:
(a) determining, from data indicative of the pattern, a pattern construct that is indicative of relative positions of the features and is also indicative of at least one of remaining allowable tolerance of the pattern and consumed tolerance of the pattern, wherein the pattern construct includes a minimum circumscribing circle which circumscribes feature figures indicative of all the features in relative positions determined by the pattern construct; and
(b) using the pattern construct to evaluate compliance of the individual feature with the virtual condition, including by determining from the minimum circumscribing circle and the virtual condition whether the pattern violates a set of allowable feature tolerances.

35. The method of claim 34, wherein the individual feature has a shape and the minimum circumscribing circle has a center, said method also including the step of:
(c) assessing the individual feature's contribution to a violation of the set of allowable feature tolerances, using data indicative of the shape of the individual feature and data indicative of a virtual condition figure centered at the center of the minimum circumscribing circle.

36. The method of claim 35, wherein the feature figures are indicative of shapes of all the features and have relative positions determined by the pattern construct.

37. The method of claim 34, wherein the individual feature has a shape and the minimum circumscribing circle has a center, said method also including the step of:
(c) determining a remaining allowable tolerance of the individual feature using data indicative of the shape of the individual feature and data indicative of a virtual condition figure centered at the center of the minimum circumscribing circle.

38. The method of claim 37, wherein the feature figures are indicative of shapes of all the features and have relative positions determined by the pattern construct.

39. The method of claim 37, wherein the feature figures include a feature figure for the individual feature, the virtual condition figure has a radius, and step (c) includes the step of:
determining minimum distance between the virtual condition figure's radius and a point on the feature figure for the individual feature that is farthest from the center of the minimum circumscribing circle.

40. The method of claim 34, wherein the individual feature has a size and a true shape, and the minimum circumscribing circle has a center, said method also including the step of:
assessing the individual feature's contribution to a violation of the set of allowable feature tolerances, using data indicative of a figure having the true shape of the individual feature and the size of the individual feature, and data indicative of a virtual condition figure centered at the center of the minimum circumscribing circle.

41. The method of claim 40, wherein the features have true shapes, the feature figures have shapes indicative of the true shapes and relative positions determined by the pattern construct, and each of the feature figures is indicative of a size of one of the features.

42. The method of claim 34, wherein the individual feature has a size and a true shape and the minimum circumscribing circle has a center, said method also including the step of:
(c) determining a remaining allowable tolerance of the individual feature using data indicative of a feature having the true shape of the individual feature and the size of the individual feature, and data indicative of a virtual condition figure centered at the center of the minimum circumscribing circle.

43. The method of claim 42, wherein the features have true shapes, the feature figures have shapes indicative of the true shapes and relative positions determined by the pattern construct, and each of the feature figures is indicative of a size of one of the features.

44. The method of claim 42, wherein the feature figures include a feature figure for the individual feature, the virtual condition figure has a radius, and step (c) includes the step of:
determining minimum distance between the virtual condition figure's radius and a point on the feature figure for the individual feature that is farthest from the center of the minimum circumscribing circle.

45. A method for evaluating compliance of an individual feature of a pattern of external features with a virtual condition, said method including the steps of:
determining, from data indicative of the pattern, a pattern construct indicative of relative positions of the features and also indicative of at least one of remaining allowable tolerance of the pattern and consumed tolerance of the pattern, wherein the pattern construct includes feature figures and a minimum circumscribing circle that circumscribes the feature figures, the minimum circumscribing circle has a center, the feature figures are indicative of shapes of all the features and have relative positions determined by the pattern construct, and the feature figures include a feature figure for the individual feature;
using the pattern construct to evaluate compliance of the individual feature with the virtual condition, including by determining the individual feature's contribution to a violation of a set of allowable feature tolerances using data indicative of a virtual condition figure centered at the center of the minimum circumscribing circle, wherein the virtual condition figure has a radius; and
determining a remaining allowable tolerance of a modified version of the individual feature, from the pattern construct, data indicative of a modified version of the individual feature, and data indicative of the radius of the virtual condition figure.

46. A machine-readable medium which stores code for programming a computer to evaluate compliance of an individual feature of a pattern of features with a virtual condition, including by:
determining, from data indicative of the pattern, a pattern construct that is indicative of relative positions of the features and is also indicative of at least one of remaining allowable tolerance of the pattern and consumed tolerance of the pattern; and
using the pattern construct to evaluate compliance of the individual feature with the virtual condition.

47. The medium of claim 46, wherein the virtual condition is indicative of feature tolerance requirements, and the code includes code for programming the computer to use the pattern construct to determine whether the individual feature violates the virtual condition and thus violates at least one of the feature tolerance requirements.

48. The medium of claim 47, wherein the individual feature violates the virtual condition, and the code includes code for programming the computer to determine a modified version of the individual feature, and a modified version of the pattern including the modified version of the individual feature in place of the individual feature, such that the modified version of the pattern does not violate the virtual condition.

49. The medium of claim 46, wherein the pattern construct is indicative of consumed tolerance of the pattern, and the code includes code for programming the computer to:
determine departure figures, including a departure figure for each of the features, wherein each said departure figure has a size indicative of size departure of one of the features relative to a true size for said one of the features, and each said departure figure has a position determined by the pattern construct; and
determine from the departure figures a consumed tolerance figure indicative of the consumed tolerance of the pattern.

50. The medium of claim 49, wherein the departure figures are departure circles, the consumed tolerance figure is a consumed tolerance circle, relative positions of the departure circles are indicative of a range of deviations of the positions of the features from true positions of said features, the features are internal features, and each of the departure circles has a diameter indicative of the difference between a size of one of the features and a minimum allowable diameter allowable for said one of the features.

51. The medium of claim 49, wherein the departure figures are departure circles, the consumed tolerance figure is a consumed tolerance circle, and the code includes code for programming the computer to determine actual tolerance consumed by the individual feature, including by determining a diameter of a smallest circle that is concentric with the consumed tolerance circle and tangent to the departure circle for said individual feature, and determining the actual tolerance consumed by the individual feature from the diameter of said smallest circle.

52. The medium of claim 49, wherein the code includes code for programming the computer to determine actual tolerance consumed by the individual feature, and to determine the total remaining tolerance for the individual feature by subtracting the actual tolerance consumed by the individual feature from a sum of allowable feature tolerances.

53. The medium of claim 49, wherein the consumed tolerance of the pattern exceeds an allowed tolerance determined by a sum of size and feature relating tolerances, and the code includes code for programming the computer to determine an amount of tolerance violation for the individual feature.

54. The medium of claim 53, wherein the code includes code for programming the computer to determine the amount of tolerance violation for the individual feature by:
determining a smaller consumed tolerance figure that is concentric with the consumed tolerance figure but has size indicative of an allowable tolerance diameter determined by the sum of size and feature relating tolerances; and
determining an amount of clearance between the smaller consumed tolerance circle the departure figure for the individual feature.

55. The medium of claim 46, wherein the features are internal features, the pattern construct includes a maximum inscribed circle which is inscribed within feature figures indicative of all the features, the feature figures have relative positions determined by the pattern construct, and the code includes code for programming the computer to determine from the maximum inscribed circle and the virtual condition whether the pattern violates a set of allowable feature relating tolerances.

56. The medium of claim 55, wherein the individual feature has a shape and the maximum inscribed circle has a center, and the code includes code for programming the computer to assess the individual feature's contribution to a violation of the set of allowable feature relating tolerances, using data indicative of the shape of the individual feature and data indicative of a virtual condition figure centered at the center of the maximum inscribed circle.

57. The medium of claim 46, wherein the features are internal features having true shapes, the pattern construct includes a maximum inscribed circle which is inscribed within feature figures having relative positions determined by the pattern construct, each of the feature figures is indicative of a size and a true shape of one of the features, and the code includes code for programming the computer to determine from the maximum inscribed circle and the virtual condition whether the pattern violates a set of allowable feature relating tolerances.

58. The medium of claim 57, wherein the individual feature has a size and a true shape, the maximum inscribed circle has a center, and the code includes code for programming the computer to assess the individual feature's contribution to a violation of the set of allowable feature relating tolerances, using data indicative of a figure having the true size of the individual feature and the size of the individual feature, and data indicative of a virtual condition figure centered at the center of the maximum inscribed circle.

59. The medium of claim 46, wherein the features are external features, the pattern construct includes a minimum circumscribing circle which circumscribes feature figures indicative of all the features, the feature figures have relative positions determined by the pattern construct, and the code includes code for programming the computer to determine from the minimum circumscribing circle and the virtual condition whether the pattern violates a set of allowable feature relating tolerances.

60. The medium of claim 59, wherein the individual feature has a shape and the minimum circumscribing circle has a center, and the code includes code for programming the computer to assess the individual feature's contribution to a violation of the set of allowable feature relating tolerances, using data indicative of the shape of the individual feature and data indicative of a virtual condition figure centered at the center of the minimum circumscribing circle.

61. The medium of claim 46, wherein the features are external features having true shapes, the pattern construct includes a minimum circumscribing circle which circumscribes feature figures having relative positions determined by the pattern construct, each of the feature figures is indicative of a size and a true shape of one of the features, and the code includes code for programming the computer to determine from the minimum circumscribing circle and the virtual condition whether the pattern violates a set of allowable feature relating tolerances.

62. The medium of claim 61, wherein the individual feature has a size and a true shape, the minimum circumscribing circle has a center, and the code includes code for programming the computer to assess the individual feature's contribution to a violation of the set of allowable feature tolerances, using data indicative of a figure having the true shape of the individual feature and the size of the individual feature, and data indicative of a virtual condition figure centered at the center of the minimum circumscribing circle.

63. A machine-readable medium which stores code for programming a computer to evaluate compliance of an individual feature of a pattern of internal features with a virtual condition, including by:
determining, from data indicative of the pattern, a pattern construct that is indicative of relative positions of the features and is also indicative of at least one of remaining allowable tolerance of the pattern and consumed tolerance of the pattern, wherein the pattern construct includes a maximum inscribed circle which is inscribed within feature figures indicative of all the features in relative positions determined by the pattern construct; and
using the pattern construct to evaluate compliance of the individual feature with the virtual condition, including by determining from the maximum inscribed circle and the virtual condition whether the pattern violates a set of allowable feature relating tolerances.

64. The medium of claim 63, wherein the individual feature has a shape and the maximum inscribed circle has a center, and the code includes code for programming the computer to assess the individual feature's contribution to a violation of the set of allowable feature relating tolerances, using data indicative of the shape of the individual feature and data indicative of a virtual condition figure centered at the center of the maximum inscribed circle.

65. The medium of claim 63, wherein the code includes code for programming the computer to determine the feature figures to be indicative of shapes of all the features and to have relative positions determined by the pattern construct.

66. The medium of claim 64, wherein the individual feature has a shape and the maximum inscribed circle has a center, and the code includes code for programming the computer to determine a remaining allowable tolerance of the individual feature using data indicative of the shape of the individual feature and data indicative of a virtual condition figure centered at the center of the maximum inscribed circle.

67. The medium of claim 66, wherein the code includes code for programming the computer to determine the feature figures to be indicative of shapes of all the features and to have relative positions determined by the pattern construct.

68. The medium of claim 63, wherein the individual feature has a size and a true shape, the maximum inscribed circle has a center, and the code includes code for programming the computer to assess individual feature's contribution to a violation of the set of allowable feature relating tolerances, using data indicative of a figure having the true shape of the individual feature and the size of the individual feature and data indicative of a virtual condition figure centered at the center of the maximum inscribed circle.

69. The medium of claim 68, wherein the code includes code for programming the computer to determine the feature figures to be indicative of true shapes of the features and to have relative positions determined by the pattern construct, such that each of the feature figures is indicative of a size of one of the features.

70. The medium of claim 63, wherein the individual feature has a size and a true shape, the maximum inscribed circle has a center, and the code includes code for programming the computer to determine a remaining allowable tolerance of the individual feature using data indicative of a figure having the true shape of the individual feature and the size of the individual feature and data indicative of a virtual condition figure centered at the center of the maximum inscribed circle.

71. A machine-readable medium which stores code for programming a computer to evaluate compliance of an individual feature of a pattern of external features with a virtual condition, including by:
(a) determining, from data indicative of the pattern, a pattern construct that is indicative of relative positions of the features and is also indicative of at least one of remaining allowable tolerance of the pattern and consumed tolerance of the pattern, wherein the pattern construct includes a minimum circumscribing circle which circumscribes feature figures indicative of all the features in relative positions determined by the pattern construct; and
(b) using the pattern construct to evaluate compliance of the individual feature with the virtual condition, including by determining from the minimum circumscribing circle and the virtual condition whether the pattern violates a set of allowable feature relating tolerances.

72. The medium of claim 71, wherein the individual feature has a shape and the minimum circumscribing circle has a center, and the code includes code for programming the computer to assess the individual feature's contribution to a violation of the set of allowable feature relating tolerances, using data indicative of the shape of the individual feature and data indicative of a virtual condition figure centered at the center of the minimum circumscribing circle.

73. The medium of claim 71, wherein the individual feature has a shape and the minimum circumscribing circle has a center, and the code includes code for programming the computer to determine a remaining allowable tolerance of the individual feature using data indicative of the shape of the individual feature and data indicative of a virtual condition figure centered at the center of the minimum circumscribing circle.

74. The medium of claim 73, wherein the code includes code for programming the computer to determine the feature figures to be indicative of shapes of all the features and have relative positions determined by the pattern construct.

75. The medium of claim 71, wherein the individual feature has a size and a true shape, the minimum circumscribing circle has a center, and the code includes code for programming the computer to assess the individual feature's contribution to a violation of the set of allowable feature relating tolerances, using data indicative of a figure having the true shape of the individual feature and the size of the individual feature and data indicative of a virtual condition figure centered at the center of the minimum circumscribing circle.

76. The medium of claim 71, wherein the individual feature has a size and a true shape, the minimum circumscribing circle has a center, and the code includes code for programming the computer to determine a remaining allowable tolerance of the individual feature using data indicative of a figure having the true shape of the individual feature and the size of the individual feature and data indicative of a virtual condition figure centered at the center of the minimum circumscribing circle.

77. A computer system, comprising:
a processor programmed to evaluate compliance of an individual feature of a pattern of features with a virtual condition, including by
determining, from data indicative of the pattern, a pattern construct that is indicative of relative positions of the features and is also indicative of at least one of remaining allowable tolerance of the pattern and consumed tolerance of the pattern; and
using the pattern construct to evaluate compliance of the individual feature with the virtual condition.

78. The system of claim 77, wherein the virtual condition is indicative of feature relating tolerance requirements, and the processor is programmed to use the pattern construct to determine whether the individual feature violates the virtual condition and thus violates at least one of the feature relating tolerance requirements.

79. The system of claim 78, wherein the individual feature violates the virtual condition, and the processor is programmed to determine a modified version of the individual feature, and a modified version of the pattern including the modified version of the individual feature in place of the individual feature, such that the modified version of the pattern does not violate the virtual condition.

80. The system of claim 77, wherein the pattern construct is indicative of consumed tolerance of the pattern, and the processor is programmed to: determine departure figures, including a departure figure for each of the features, wherein each said departure figure has size indicative of size departure of one of the features relative to a true size for said one of the features, and each said departure figure has a position determined by the pattern construct; and
determine from the departure figures a consumed tolerance figure indicative of the consumed tolerance of the pattern.

81. The system of claim 80, wherein the departure figures are departure circles, the consumed tolerance figure is a consumed tolerance circle, relative positions of the departure circles are indicative of a range of deviations of the positions of the features from true positions of said features, the features are internal features, and each of the departure circles has a diameter indicative of the difference between a size of one of the features and a minimum allowable diameter allowable for said one of the features.

82. The system of claim 80, wherein the departure figures are departure circles, the consumed tolerance figure is a consumed tolerance circle, and the processor is programmed to determine actual tolerance consumed by the individual feature, including by determining a diameter of a smallest circle that is concentric with the consumed tolerance circle and tangent to the departure circle for said individual feature, and determining the actual tolerance consumed by the individual feature from the diameter of said smallest circle.

83. The system of claim 80, wherein the processor is programmed to determine actual tolerance consumed by the individual feature, and to determine the total remaining tolerance for the individual feature by subtracting the actual tolerance consumed by the individual feature from a sum of allowable feature tolerances.

84. The system of claim 80, wherein the consumed tolerance of the pattern exceeds an allowed tolerance determined by the virtual condition, and the processor is programmed to determine an amount of tolerance violation for the individual feature.

85. The system of claim 84, wherein the processor is programmed to determine the amount of tolerance violation for the individual feature by:
determining a smaller consumed tolerance figure that is concentric with the consumed tolerance figure but has size indicative of an allowable tolerance diameter determined by the feature tolerances; and
determining an amount of clearance between the smaller consumed tolerance circle the departure figure for the individual feature.

86. The system of claim 77, wherein the features are internal features, the pattern construct includes a maximum inscribed circle which is inscribed within feature figures indicative of all the features, the feature figures have relative positions determined by the pattern construct, and the processor is programmed to determine from the maximum inscribed circle and the virtual condition whether the pattern violates a set of allowable feature relating tolerances.

87. The system of claim 86, wherein the individual feature has a shape and the maximum inscribed circle has a center, and the processor is programmed to assess the individual feature's contribution to a violation of the set of allowable feature relating tolerances, using data indicative of the shape of the individual feature and data indicative of a virtual condition figure centered at the center of the maximum inscribed circle.

88. The system of claim 77, wherein the features are internal features having true shapes, the pattern construct includes a maximum inscribed circle which is inscribed within feature figures having relative positions determined by the pattern construct, each of the feature figures is indicative of a size and a true shape of one of the features, and the processor is programmed to determine from the maximum inscribed circle and the virtual condition whether the pattern violates a set of allowable feature relating tolerances.

89. The system of claim 88, wherein the individual feature has a size and a true shape, the maximum inscribed circle has a center, and the processor is programmed to assess the individual feature's contribution to a violation of the set of allowable feature relating tolerances, using data indicative of a figure having the true size of the individual feature and the size of the individual feature, and data indicative of a virtual condition figure centered at the center of the maximum inscribed circle.

90. The system of claim 77, wherein the features are external features, the pattern construct includes a minimum circumscribing circle which circumscribes feature figures indicative of all the features, the feature figures have relative positions determined by the pattern construct, and the processor is programmed to determine from the minimum circumscribing circle and the virtual condition whether the pattern violates a set of allowable feature relating tolerances.

91. The system of claim 90, wherein the individual feature has a shape and the minimum circumscribing circle has a center, and the processor is programmed to assess the individual feature's contribution to a violation of the set of allowable feature relating tolerances, using data indicative of the shape of the individual feature and data indicative of a virtual condition figure centered at the center of the minimum circumscribing circle.

92. The system of claim 77, wherein the features are external features having true shapes, the pattern construct includes a minimum circumscribing circle which circumscribes feature figures having relative positions determined by the pattern construct, each of the feature figures is indicative of a size and a true shape of one of the features, and the processor is programmed to determine from the minimum circumscribing circle and the virtual condition whether the pattern violates a set of allowable feature relating tolerances.

93. The system of claim 92, wherein the individual feature has a size and a true shape, the minimum circumscribing circle has a center, and the processor is programmed to assess the individual feature's contribution to a violation of the set of allowable feature relating tolerances, using data indicative of a figure having the true shape of the individual feature and the size of the individual feature, and data indicative of a virtual condition figure centered at the center of the minimum circumscribing circle.

94. A computer system, comprising:
a processor programmed to evaluate compliance of an individual feature of a pattern of internal features with a virtual condition, including by:
determining, from data indicative of the pattern, a pattern construct that is indicative of relative positions of the features and is also indicative of at least one of remaining allowable tolerance of the pattern and consumed tolerance of the pattern, wherein the pattern construct includes a maximum inscribed circle which is inscribed within feature figures indicative of all the features in relative positions determined by the pattern construct; and
using the pattern construct to evaluate compliance of the individual feature with the virtual condition, including by determining from the maximum inscribed circle and the virtual condition whether the pattern violates a set of allowable feature relating tolerances.

95. The system of claim 94, wherein the individual feature has a shape the maximum inscribed circle has a center, and the processor is programmed to assess the individual feature's contribution to a violation of the set of allowable feature relating tolerances, using data indicative of the shape of the individual feature and data indicative of a virtual condition figure centered at the center of the maximum inscribed circle.

96. The system of claim 95, wherein the processor is programmed to determine the feature figures to be indicative of shapes of all the features and to have relative positions determined by the pattern construct.

97. The system of claim 95, wherein the individual feature has a shape and the maximum inscribed circle has a center, and the processor is programmed to determine a remaining allowable tolerance of the individual feature using data indicative of the shape of the individual feature and data indicative of a virtual condition figure centered at the center of the maximum inscribed circle.

98. The system of claim 97, wherein the processor is programmed to determine the feature figures to be indicative of shapes of all the features and to have relative positions determined by the pattern construct.

99. The system of claim 94, wherein the individual feature has a size and a true shape, the maximum inscribed circle has a center, and the processor is programmed to assess individual feature's contribution to a violation of the set of allowable feature relating tolerances, using data indicative of a figure having the true shape of the individual feature and the size of the individual feature and data indicative of a virtual condition figure centered at the center of the maximum inscribed circle.

100. The system of claim 99, wherein the processor is programmed to determine the feature figures to be indicative of true shapes of the features and to have relative positions determined by the pattern construct, such that each of the feature figures is indicative of a size of one of the features.

101. The system of claim 94, wherein the individual feature has a size and a true shape, the maximum inscribed circle has a center, and the processor is programmed to determine a remaining allowable tolerance of the individual feature using data indicative of a figure having the true shape of the individual feature and the size of the individual feature and data indicative of a virtual condition figure centered at the center of the maximum inscribed circle.

102. A computer system, comprising:
a processor programmed to evaluate compliance of an individual feature of a pattern of external features with a virtual condition, including by:
(a) determining, from data indicative of the pattern, a pattern construct that is indicative of relative positions of the features and is also indicative of at least one of remaining allowable tolerance of the pattern and consumed tolerance of the pattern, wherein the pattern construct includes a minimum circumscribing circle which circumscribes feature figures indicative of all the features in relative positions determined by the pattern construct; and
(b) using the pattern construct to evaluate compliance of the individual feature with the virtual condition, including by determining from the minimum circumscribing circle and the virtual condition whether the pattern violates a set of allowable feature relating tolerances.

103. The system of claim 102, wherein the individual feature has a shape and the minimum circumscribing circle has a center, and the processor is programmed to assess the individual feature's contribution to a violation of the set of allowable feature relating tolerances, using data indicative of the shape of the individual feature and data indicative of a virtual condition figure centered at the center of the minimum circumscribing circle.

104. The system of claim 102, wherein the individual feature has a shape, the minimum circumscribing circle has a center, and the processor is programmed to determine a remaining allowable tolerance of the individual feature using data indicative of the shape of the individual feature and data indicative of a virtual condition figure centered at the center of the minimum circumscribing circle.

105. The system of claim 104, wherein the processor is programmed to determine the feature figures to be indicative of shapes of all the features and have relative positions determined by-the pattern construct.

106. The system of claim 102, wherein the individual feature has a size and a true shape, the minimum circumscribing circle has a center, and the processor is programmed to assess the individual feature's contribution to a violation of the set of allowable feature relating tolerances, using data indicative of a figure having the true shape of the individual feature and the size of the individual feature and data indicative of a virtual condition figure centered at the center of the minimum circumscribing circle.

107. The system of claim 102, wherein the individual feature has a size and a true shape, the minimum circumscribing circle has a center, and the processor is programmed to determine a remaining allowable tolerance of the individual feature using data indicative of a figure having the true shape of the individual feature and the size of the individual feature and data indicative of a virtual condition figure centered at the center of the minimum circumscribing circle.
